(19) United States
(12) Patent Application Publication
(10) Pub. No.: US 2024/0271700 A1
(43) Pub. Date: Aug. 15, 2024

(54) Parking Lock Device and Parking Lock Device of an Automatic Transmission

(71) Applicant: ZF Friedrichshafen AG, Friedrichshafen (DE)

(72) Inventors: Matthias List, Friedrichshafen (DE); Manuel Jung, Eriskirch (DE); Tobias Pfleger, Salem (DE); Stefan Ott, Meßkirch (DE)

(21) Appl. No.: 18/422,659

(22) Filed: Jan. 25, 2024

(30) Foreign Application Priority Data
Jan. 25, 2023 (DE) 102023200554.9

(51) Int. Cl. F16H 63/34

(52) U.S. Cl. CPC F16H 63/3483; F16H 63/3433; F16H 63/3491

(57) ABSTRACT

A parking lock device for an automatic transmission includes an actuator having a piston axially movable within an actuator housing between a first piston position and a second piston position. A guide section of the piston axially extends through an opening defined in the actuator housing, where a length of the piston extending outside of the actuator housing is longer when the piston is in the second piston position than when in the first piston position. An emergency actuation device is outside of the actuator housing and is operatively connectable with the piston such that the piston is movable by the emergency actuation device from the first piston position into the second piston position. An actuation-travel-limiting unit is contacted by the emergency actuation device to limit further axial displacement of the piston by the emergency actuation device beyond the second piston position.

### CROSS-REFERENCE TO RELATED APPLICATION

The present application is related and has right of priority to German Patent Application No. 10 2023 200 554.9 filed on Jan. 25, 2023, the entirety of which is incorporated by reference for all purposes.

### FIELD OF THE INVENTION

The present invention relates generally to a parking lock device, in particular to a parking lock device of an automatic transmission of a motor vehicle, where the parking lock device has a hydraulically or pneumatically controllable actuator. The invention also relates generally to a transmission having such a parking lock device.

### BACKGROUND

Parking lock devices and parking locks are known from practical experience, by which motor vehicles are secured against rolling away. Such parking locks are provided, for example, in motor vehicles which have automatic or automated transmissions, and mechanically act on output shafts of the transmissions. Furthermore, electric-motor-driven drive axles of motor vehicles are also assigned parking locks, which mechanically act on the two output-side half shafts of such drive axles. These types of parking locks usually each include at least one locking pawl, where each locking pawl is pivotably mounted on a pawl pin and interlockingly engages into a parking interlock gear connected to the output of the transmission or to the drive axle to secure the parking interlock gear against rotation, or disengages from the parking interlock gear to release the parking interlock gear.

A parking lock is usually engaged mechanically via the spring force of an engagement spring. A hydraulic actuator is frequently provided for disengaging the parking lock. In the hydraulic actuator, one end of a connecting rod, which faces away from a blocking element, is articulatedly connected to a selector disk. The selector disk is operatively connected to a piston rod of a hydraulic piston, which is hydraulically actuatable and arranged in a bore in the actuator housing. The parking lock is engaged by the preloaded engagement spring and is transferred into the disengaged state when the hydraulic piston is axially displaced against the force of an engagement spring.

In order to hydraulically actuate such a parking lock, pressure is supplied to the pressure chamber of the actuator, the pressure chamber being formed by the lateral surface of the housing bore together with the hydraulic piston. As a result, the hydraulic piston is axially displaced against the spring force of the engagement spring into its disengaged piston position which is associated with the disengaged state of the parking lock. In the process, the compressive force of the hydraulic piston guides the blocking element out of its blocking position and out of engagement with the parking interlock gear.

In order to additionally lock the hydraulic piston of the actuator in the disengaged state of the parking lock, an electromagnet is usually provided, which is electrically energized in the disengaged operating state of the parking lock. Thereupon, a catch mechanism acting on the hydraulic piston is actuated by the electromagnet. The catch mechanism is provided to prevent an undesirable disengagement of the parking lock in the event of a pressure drop in the pressure chamber. Such a pressure drop arises, for example, during a longer interruption of operation of a vehicle. Thereupon, the oil volume which is initially present in the pressure chamber flows out of the pressure chamber during the downtime of the vehicle due to gravity and due to existing leaks in the oil-conducting region of the parking lock, thereby draining the pressure chamber.

In order to engage the parking lock, a solenoid valve is de-energized, which causes the pressure chamber to be evacuated. In addition, the mechanical interlock of the hydraulic piston of the actuator is released. Thereupon, the hydraulic piston is transferred by the preloaded engagement spring into its engaged position (parking lock engaged). In the process, the blocking element is moved underneath the locking pawl. The blocking element then acts on the locking pawl such that a tooth of this locking pawl engages into a corresponding tooth gap in locking toothing of the parking interlock gear. The catch mechanism, which has already been provided for mechanically locking the actuator piston in the disengaged position, is modifiable or adaptable such that it usable to also mechanically lock the actuator piston in the engaged position. In this case, an electromagnet is also sufficient for locking the actuator piston either in the disengaged position or in the engaged position. A person skilled in the art refers to this type of parking lock actuating system as a hydraulically actuatable parking lock actuator having bistable piston interlock.

A device for actuating a parking lock of a transmission is known, for example, from DE 10 2017 218 748 A1. An engagement spring is provided for engaging the parking lock, the spring force of which acts on a selector lever in the engagement direction of the parking lock. The selector lever acts via a connecting rod on a blocking element of the parking lock and the blocking element acts on the locking pawl of the parking lock. A hydraulically controllable actuator is provided for disengaging the parking lock, the compressive force of which acts on the selector lever in the disengagement direction of the parking lock. In order to be able to manually disengage the parking lock as necessary, the parking lock additionally includes an emergency release device, which is bringable into an operative connection with the selector lever.

Additionally, the actuator from DE 10 2017 218 748 A1 has two pistons, which are arranged so as to be axially movable in an actuator housing on the same longitudinal axis, and an electromagnetically actuatable catch device which is arranged in the actuator housing. The first piston is hydraulically acted on with pressure in order to disengage the parking lock, for instance, when pressure-loaded, the first piston moves the second piston in the axial direction against the spring force of the engagement spring. The second piston is mechanically connected to the selector lever such that an axial movement of the second piston brings about a pivoting of the selector lever, and a pivoting of the selector lever results in an axial movement of the second piston.

The catch device is actuatable by an electromagnet. The catch device mechanically locks the first piston either in a piston position associated with the engaged state of the parking lock or in a piston position associated with the disengaged state of the parking lock when the electromagnet is not energized. The electromagnet must be energized in order to release the catch in the respective piston position. This structural design makes it possible, upon actuation of the emergency release device, for the second piston to be moved axially by the selector lever without the first piston leaving its latched piston position, which corresponds to the engaged state of the parking lock. Typically, the parking lock is mechanically actuatable from the outside via an emergency release. According to known parking lock devices, the mechanical stop of the emergency release is implemented by the hydraulic stop of the actuator.

As compared to the type of actuation described above, actuating systems operating in an inverted manner are also known. In these systems, the parking lock is hydraulically engaged and is mechanically disengaged by spring force.

Usually, pressure medium is supplied to the pressure chamber of a parking lock actuator and this pressure chamber is evacuated via a control valve or multiple hydraulically interacting control valves of an electrohydraulic control unit of a transmission or an aforementioned electric motor-driven drive axle. Such an electrohydraulic control unit is supplied with hydraulic fluid by an oil pump. The oil pump is drivable by a prime mover which is provided for driving the transmission, or by an electric machine which is provided for driving the drive axle, or also by a separate electric motor.

It is problematic, however, when the actuating forces of the emergency release during release exceed the maximum permissible load capacity of an entrainer pin or a retaining pin on the piston, on which the emergency release lever engages, of the piston itself, of the piston guide or of the actuator housing. A service life of the parking lock device is negatively affected as a result.

### SUMMARY OF THE INVENTION

On the basis thereof, aspects of the present invention provide a structurally simple and economical parking lock device and a transmission having such a parking lock device, each of which is characterized by a long service life.

The invention is directed to a parking lock device, in particular a parking lock device of an automatic transmission of a vehicle, where the parking lock device has a hydraulically or pneumatically controllable actuator. The actuator includes at least one piston, which is axially movably arranged in a housing of the actuator. The piston is acted on with pressure medium in order to actuate the parking lock device a first piston position, in which the parking lock device is in a first engagement position and is disengaged or engaged, into a second piston position, in which the parking lock device is in a second engagement position and is engaged or disengaged.

A guide section of the piston extends through an opening in the actuator housing in an axial direction, via which the piston is guided in the actuator housing, where the guide section is a piston rod. In addition, the piston is bringable into an operative connection with an emergency actuation device or an emergency release device outside the actuator housing. By the emergency actuation device, the piston is movable from the first piston position into the second piston position. A length of the region of the piston arranged outside the actuator housing is greater when the piston is in the second piston position than in the first piston position.

According to the invention, the actuation travel of the piston during an actuation of the piston by the emergency actuation device from the first piston position towards the second piston position is limited by an actuation-travel-limiting unit in the region of the emergency actuation device. In particular, a stop system is realized outside the actuator and within the transmission, where the stop system is able to endure the actuating forces.

It is therefore ensured that the actuation travel of the piston during an emergency actuation is limited in the region of the emergency actuation device and by its actuation-travel-limiting unit. As a result, it is easily ensured that the actuator housing, an operative connection between the piston and the emergency actuation device, and the piston are prevented from being acted on with undesirably high loads when the piston reaches its second piston position. In this way, the function of the parking lock device is not adversely affected and the service life of the parking lock device is not shortened to an undesirable extent.

The actuation-travel limitation is implementable in a structurally simple manner, since, depending on the design of the actuation-travel-limiting unit, only tolerance chains having a small number of individual tolerances are to be taken into account in each case. This substantially simplifies a manufacturing process, with which the parking lock device according to aspects of the invention is also economically manufactured.

The emergency actuation device in one development of the parking lock device according to the invention includes a control lever or selector lever, which is mounted on the housing so as to be rotatable about an axis of rotation. The control lever is operatively connectable to a driving part of the piston such that rotational motion of the control lever in a first direction of rotation of the control lever causes the piston to be transferred from its first piston position into its second piston position. The actuation-travel-limiting unit has a stop surface in the region of a housing, where the stop surface interacts with the contact area of the control lever. For instance, the contact area of the control lever rests against the stop surface when the piston is in the second piston position, in order to prevent further rotational motion of the control lever and further an axial actuating motion of the piston beyond the second piston position. As a result, an introduction of impermissible loads, which adversely affects the mode of operation of the actuator and, therefore, of the parking lock device and results in damage to the load-carrying actuator parts, are easily avoided.

When a perpendicular distance between the axis of rotation of the control lever and the contact area of the control lever and a perpendicular distance between the axis of rotation of the control lever and stop surface are both greater than a predefined threshold value, manufacturing-related manufacturing tolerances have only a minor effect on the function of the actuation-travel-limiting unit.

Furthermore, the emergency actuation device of the parking lock device according to the invention is structurally simple and has low component stiffness when the contact area of the control lever and the stop surface lie in the plane of rotation of the control lever. This is the case, since there is substantially no significant tipping torque to be supported in the region of the emergency actuation device, which acts at the control lever, when the control lever rests with its contact area on the stop surface and the piston is in its second piston position.

If the contact area of the control lever and the stop surface are offset with respect to the plane of rotation of the control lever along the axis of rotation of the control lever, respective available installation spaces are advantageously usable.

In one embodiment of the parking lock device according to the invention, which is structurally simply and economically manufactured, the contact area of the control lever is provided in the region of an outer side of a hollow cylindrical sleeve connected to the control lever, where the hollow cylindrical sleeve extends from one lateral face of the control lever in the axial direction of the axis of rotation of the control lever.

The stop surface is essentially perpendicular to the axial actuating motion of the piston or at least approximately parallel to the axial actuating motion of the piston, in order to be able to limit the actuation travel of the piston to the desired extent. It is also possible that the stop surface and the actuation direction of the piston enclose an acute angle with one another in the clockwise direction or in the counterclockwise direction depending on particular current application.

The control lever is economically a stamped and bent sheet-metal part. When the contact area of the control lever has a bent shape, the contact area has a contact surface which is as large as possible while simultaneously requiring a small amount of required installation space. As a result, only a low contact pressure arises between the contact area of the control lever and the stop surface of the housing.

In embodiments which are economical and easily manufactured and are each characterized as being structurally simple, the stop surface is an end face of an L-shaped component, a lateral face of a flat bar, or a lateral face of a flat mounting plate.

The L-shaped component or the flat bar is connected or connectable to the housing, preferably to a housing of a hydraulic control unit of the automatic transmission, in an integrally bonded, frictional and/or interlocking manner.

It is possible that the flat mounting plate is connected to the housing, preferably to a housing of a hydraulic control unit of the automatic transmission, in the region of multiple mutually spaced fastening regions in an integrally bonded, frictional and/or interlocking manner, the fastening regions lying substantially at the level of the stop surface.

The mounting plate, in some instances, includes multiple support regions, each of which extends away from the fastening regions in a finger-like manner and rests against the outer side of the housing, preferably against the housing of the hydraulic transmission control unit. As a result, a rigid connection is established between the mounting plate and the housing while ensuring high component stiffness and low component weight of the mounting plate.

When the finger-like support regions are bent, in the installed state, the support regions rest against the housing of the hydraulic transmission control unit with preload, as such, a rigid connection is established between the housing and the mounting plate even in the presence of greater component tolerances.

The mounting plate additionally has, in some instances, at least one folded edge which increases the component stiffness of the mounting plate.

The actuator, in some instances, includes two pistons, which are arranged so as to be axially movable in the actuator housing on the same longitudinal axis. The further piston, which is referred to in the following as the first piston, is acted on with pressure medium in order to actuate the parking lock. When pressure is applied on the first piston, the first piston displaces the piston which is referred to in the following as the second piston, against the spring force of a spring axially out of a first piston position, in which the parking lock is disengaged or engaged, into a second piston position, in which the parking lock is engaged or disengaged. The first piston is also transferred from a first piston position into its second piston position. The two pistons rest against one another in the region of mutually facing axial end faces at least during the displacement of the second piston by the first piston. The first piston is mechanically fixable at least in the first piston position by a locking device.

An axial distance between the end faces of the pistons when both pistons are in the first piston positions is smaller than an axial distance between the end faces of the pistons when the first piston is in the first piston position and the second piston is in the second piston position. In addition, the second piston is connected or operatively connected to a blocking element.

It is additionally possible that the second piston is axially displaceable with respect to the first piston from the first piston position into the second piston position against the spring force of the spring by the emergency actuation device.

The parking lock device is, for example, manually actuatable via the emergency actuation device, without the first piston of the actuator leaving its mechanically fixed piston position during the manual actuation of the parking lock device.

In addition, a stop device is provided, which holds the second piston in its first piston position against the spring force of the spring.

It is therefore ensured that the second piston is transferred, for example, after an emergency actuation via the emergency actuation device, by the spring into its first piston position and is stopped and held in the first piston position by the stop device. As a result, the second piston is easily prevented from impacting the end face of the first piston via its end face and introducing an undesirably high impulse into the first piston, which adversely affects the function of the parking lock device and, therefore, shortens the service life of the parking lock device.

The stop device is also implementable in a structurally simple manner, since, depending on the design of the stop device, only tolerance chains having a small number of individual tolerances are to be taken into account in each case. This substantially simplifies a manufacturing process, with which the parking lock device according to the invention is also economically manufactured.

The second piston, in some instances, has a projection of the stop device in the region which is located outside the actuator housing and represents a piston rod. The projection is fixedly connected to the piston rod. In the first piston position of the second piston, the projection then rests against a housing-side stop surface of the stop device and supports the second piston against the stop surface in a structurally simple manner against the spring force of the spring in the first piston position of the second piston.

In one development of the parking lock device according to the invention, a selector lever connects the second piston to a blocking element of the parking lock device. The selector lever is operatively connected to the second piston and the blocking element and is pivoted by the second piston during an axial displacement of the second piston, as a result of which the blocking element is actuated to the desired extent.

In one embodiment of the parking lock device according to the invention, which is favorable with respect to installation space and is able to be integrated into existing parking lock systems with little effort, the selector lever rests against a stop surface of the stop device on the housing in the first piston position of the second piston and holds the second piston in its first piston position against the spring force of the spring.

The selector lever is transferrable by the preferably manually actuatable control lever in a structurally simple manner against the spring force of the spring, which acts on the second piston, from its first pivot position, which is associated with the first piston position of the second piston, into a second pivot position. The second pivot position of the selector lever is associated with the second piston position of the second piston.

The control lever rests against a stop surface of the stop device on the housing in the first pivot position and holds the second piston in the first piston position via the selector lever against the spring force of the spring.

Such an embodiment of the parking lock device according to the invention, in comparison to known parking locks, requires little additional installation space and is able to be integrated into existing parking lock systems with little structural complexity.

The stop surface of the stop device on the housing is provided or defined in the region of the housing of the actuator with little effort.

For example, in an embodiment of the housing of the actuator made of plastic, it is therefore possible to produce the stop surface by overmolding an additional region on the housing of the actuator. The additional region of the housing is configured in a load-appropriate manner by an injected metal insert.

Furthermore, the stop surface of the stop device is also provided with little effort, in each case, in the region of metal housings of known parking lock systems by a suitable casting process.

In one development of the parking lock device according to the invention, one axial end of the first piston, which faces away from the second piston, is spaced apart from the housing of the actuator in an axial direction in the first piston position of the first piston. As a result, it is easily ensured that an undesirably high impulse is not introduced by the second piston into the housing of the actuator via the first piston.

In one further embodiment of the parking lock device according to the invention, an end-position damping unit is provided between the pistons. By the end-position damping unit, an actuating speed of the second piston is reduced prior to reaching the first piston position of the second piston and, therefore, a load on the actuator is limited.

In one embodiment for the parking lock device which is favorable with respect to installation space, the locking device includes an electromagnet and latching elements which are actuatable by the armature rod of the electromagnet.

When the first piston, which is acted on with pressure medium, is mechanically fixed by the locking device, the latching elements are axially supported directly against a support surface of the first piston against the spring force of the spring.

Furthermore, it is also provided that the latching elements are supported against a support surface of a sleeve, where the sleeve is axially movably mounted on the first piston and, when the first piston is mechanically fixed by the locking device, the sleeve is axially supported against an abutment shoulder of the first piston against the spring force of the spring.

Preferably, the locking device mechanically fixes the first piston of the actuator, which is acted on with pressure, in the respective present piston position when the electromagnet of the locking device is not electrically energized. In this case, the electromagnet must be electrically energized in order to release the piston fixation in the respective piston position, enabling the first piston of the actuator to change its piston position only when the electromagnet is electrically energized.

For this purpose, alternatively, it is also provided, however, that the locking device mechanically fixes the first piston of the actuator in the respective present piston position when the electromagnet of the locking device is electrically energized. The electromagnet must be electrically switched off in order to release the piston fixation in the respective piston position, enabling the first piston of the actuator to change its piston position only when the electromagnet is not electrically energized.

Preferably, the locking device acts directly on the first piston when locking or when axially fixing this first piston of the actuator. Alternatively, it is also provided, however, that the locking device acts indirectly on the first piston when locking this first piston of the actuator, for example, via a piston rod, which is connected to this first piston.

The actuator is suitable for use as an actuating element for parking lock devices of highly diverse types, in fact of any type. Therefore, it is provided, for example, that the compressive force of the actuator acts in the disengagement direction of the parking lock, whereas the spring force of the spring acts in the engagement direction of the parking lock. Alternatively, it is provided, for example, that the compressive force of the actuator acts in the engagement direction of the parking lock device, whereas the spring force of the spring acts in the disengagement direction of the parking lock device.

The use of the parking lock device according to the invention is also not limited to one specific application. The parking lock device according to the invention is associated, for example, with a transmission of a motor vehicle and with an electric-motor-driven drive axle of a motor vehicle.

### BRIEF DESCRIPTION OF THE DRAWINGS

The invention is described in greater detail in the following, as an example, with reference to the attached figures, wherein:

FIG. 1 shows a simplified schematic sectional view of an automatic transmission which includes a parking lock device and an emergency actuation device for manually actuating the parking lock device;

FIG. 2 shows a side view of the parking lock device of FIG. 1, wherein the emergency actuation device is shown in the non-actuated state;

FIG. 3 shows another side view of the parking lock device corresponding to FIG. 2, the emergency actuation device being shown in the actuated state;

FIG. 4 shows a bottom view of the automatic transmission and of the parking lock device according to FIG. 2;

FIG. 5 shows a partial, perspective view of a housing of a hydraulic transmission control unit, on which a stop surface of an actuation-travel-limiting unit of the emergency actuation device of FIGS. 1-5 is provided;

FIG. 6 shows a perspective view of a control lever of the emergency actuation device of FIGS. 1-5, the control lever having a hollow cylindrical sleeve, the outer side of which forms a contact area of the actuation-travel-limiting unit;

FIG. 7 shows a partial, perspective view of the housing of a hydraulic transmission control unit, on which the stop surface of one further embodiment of the actuation-travel-limiting unit is provided;

FIG. 8 shows a side view of the automatic transmission and of an embodiment of the parking lock device corresponding to FIG. 3, the parking lock device having a control lever according to FIG. 6 and a stop surface according to FIG. 7, wherein the emergency actuation device is shown in the non-actuated state;

FIG. 9 shows another side view of the parking lock device corresponding to FIG. 8, wherein the emergency actuation device is shown in the actuated state;

FIG. 10 shows a partial, perspective view of the parking lock device according to FIG. 8 from above, wherein the emergency actuation device is shown in the actuated state;

FIG. 11 shows a perspective view of one further embodiment of the control lever, which corresponds to FIG. 6, the control lever having a hollow cylindrical sleeve;

FIG. 12 shows a side view of one further embodiment of the parking lock device, which corresponds to FIG. 8, wherein the parking lock device has a control lever according to FIG. 11, the contact area of the control lever being positioned approximately perpendicular to the axial actuating motion of the piston, wherein the emergency actuation device is not activated;

FIG. 13 shows a side view of the parking lock device corresponding to FIG. 12, wherein the emergency actuation device is shown in the actuated state;

FIG. 14 shows a side view of one further embodiment of the parking lock device, which corresponds to FIG. 12, the parking lock device having a control lever according to FIG. 11 and in which the stop surface of the actuation-travel-limiting unit is arranged approximately parallel to the axial actuating motion of the piston, wherein the emergency actuation device is inactive;

FIG. 15 shows another side view of the parking lock device corresponding to FIG. 14, wherein the emergency actuation device is shown in the actuated state;

FIG. 16a and FIG. 16b each show a perspective drawing of one further embodiment of the control lever of the emergency actuation device;

FIG. 17 shows a side view of one further embodiment of the parking lock device, which corresponds to FIG. 12, the parking lock device having a control lever according to FIG. 16a, the contact area of which interacts with a stop surface of the actuation-travel-limiting unit, the stop surface being arranged substantially parallel to the axial actuating motion of the piston, wherein the emergency actuation device is inactive;

FIG. 18 shows another side view of the parking lock device corresponding to FIG. 17, wherein the emergency actuation device is shown in the actuated state;

FIG. 19 shows an rear end view of the parking lock device according to FIG. 17, wherein the emergency actuation device is shown in the non-actuated state;

FIG. 20 shows another rear end view of the parking lock device corresponding to FIG. 19, wherein the emergency actuation device is shown in the actuated state;

FIG. 21 shows a perspective view of one further embodiment of the control lever of the actuation-travel-limiting unit corresponding to FIG. 11;

FIG. 22 shows a partial, perspective view of the housing of the hydraulic transmission control unit which includes an L-shaped component in the form of a screw-on part, one end face forming the stop surface of the actuation-travel-limiting unit;

FIG. 23 shows a perspective view of an L-shaped component of the parking lock device according to FIG. 22;

FIG. 24 shows a side view of one further embodiment of the parking lock device corresponding to FIG. 18, the parking lock device including the control lever according to FIG. 21 and the L-shaped component according to FIG. 23, wherein the emergency actuation device is shown in the non-actuated state;

FIG. 25 shows another side view of the parking lock device corresponding to FIG. 24, wherein the emergency actuation device is shown in the actuated state;

FIG. 26 shows a perspective view of one further embodiment of the parking lock device, in which the stop surface of the actuation-travel-limiting unit is provided in the region of a lateral face of a flat bar, wherein the emergency actuation device is shown in the non-actuated state;

FIG. 27 shows a side view of the parking lock device according to FIG. 26, the view corresponding to FIG. 18, wherein the emergency actuation device is shown in the non-actuated state;

FIG. 28 shows another side view of the parking lock device corresponding to FIG. 27, wherein the emergency actuation device is shown in the actuated state;

FIG. 29 shows a partial, perspective view of one further embodiment of the parking lock device in the actuated state of the emergency actuation device, wherein the stop surface of the actuation-travel-limiting unit is a lateral face of a flat mounting plate which has multiple support regions;

FIG. 30 shows a partial side view of the parking lock device according to FIG. 29 in the engaged state, wherein the emergency actuation device is shown in the non-actuated state;

FIG. 31 shows another partial side view of the parking lock device according to FIG. 29 in the disengaged state, wherein the emergency actuation device is not actuated; and

FIG. 32 shows a further partial side view of the parking lock device according to FIG. 29, wherein the emergency actuation device is shown in the actuated state.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

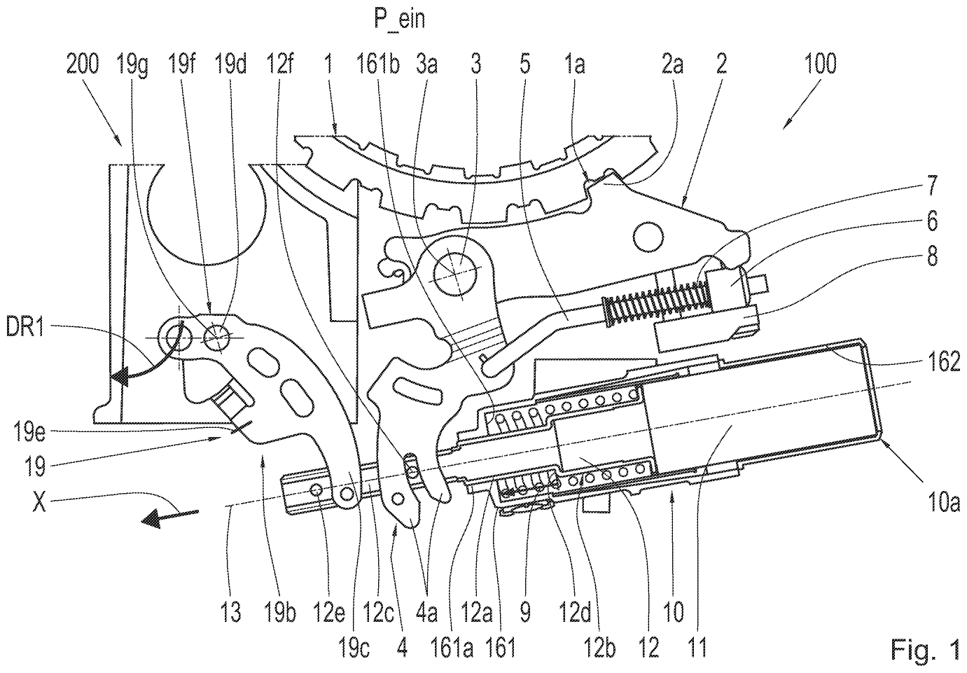

FIG. 1 shows a simplified schematic sectional view of a parking lock device 100 which includes a hydraulically actuatable actuator 10 for actuating the parking lock device 100.

The parking lock device 100 in FIG. 1 is shown in the “parking lock engaged” engagement position, which is labeled with the reference character P_ein. The parking lock device 100 is also transferrable into a disengaged operating state P_aus (illustrated in subsequent figures) and into the “parking lock disengaged” engagement position in the manner described in greater detail in the following.

As is apparent in FIG. 1, the parking lock device 100 includes a locking pawl 2, which is pivotably mounted on a pawl pin 3. A ratchet tooth 2a of the locking pawl 2 engages into or out of a tooth gap 1a in locking toothing of a parking interlock gear 1 depending on the engagement position P_ein or P_aus of the parking lock device 100. The parking interlock gear 1 is connected to a transmission shaft (not shown in greater detail) of a motor vehicle transmission for conjoint rotation. The parking lock device 100 additionally includes a blocking element 6, which is arranged on a connecting rod 5. The connecting rod 5 is connected to a selector lever 4. The blocking element 6 is spring-loaded via a spring element 7 and is clamped between the locking pawl 2 and a guide plate 8 on a transmission housing in the blocked state, i.e., in the engaged engagement state of the parking lock device 100. Therefore, the ratchet tooth 2a is prevented from being forced out of the corresponding tooth gap 1a in the parking interlock gear 1. The blocking element 6 is shaped as a cone, for example.

The selector lever 4 is also rotatably mounted on the pawl pin 3, such that the pawl pin longitudinal axis 3a, the locking pawl pivot axis, and the selector-lever axis of rotation are identical. The end of the connecting rod 5 facing away from the blocking element 6 is articulatedly connected to the selector lever 4. In order to be able to engage and disengage the parking lock device 100, the selector lever 4 has a driving part 4a, which is connected to the hydraulically or pneumatically actuatable actuator 10. The engagement position of the parking lock device 100 is specifiable by the actuator 10.

The actuator 10 has two separate pistons, a first piston 11 and a second piston 12, which are axially movable in a housing 10a of the actuator 10 on the same longitudinal axis 13, where only the first piston 11 of such pistons is hydraulically acted on with pressure in order to disengage the parking lock device 100. The housing 10a of the actuator 10 has two housing parts, a first housing part 161 and a second housing part 162, in the present case, the two housing parts 161, 162 being fixedly connected to each other. Therefore, the parking lock device 100 is installable with little effort. As set forth in the present invention, the furst hydraulic piston 11 is located in the second housing part 162 where it is selectively locked in position. For the sake of simplicity, this is not shown in greater detail.

A spring 9, a compression spring, is mounted between an end face 12d of the second piston 12 and an internal stop surface of the first housing part 161 of the actuator housing 10a, and concentrically surrounds a first guide section 12a and a guide section 12b of the second piston 12. A piston rod 12c of the second piston 12 is longitudinally displaceably guided in the region of an opening or bore 161a in the first housing part 161 and also extends partially outside the housing 10a. The second piston 12 is mechanically connected to the selector lever 4 via a pin 12f. The pin 12f is inserted, from outside the first housing part 161, into the piston rod 12c and engages into the driving part 4a of the selector lever 4. An axial movement of the second piston 12 therefore brings about a rotation of the selector lever 4 about the selector-lever axis of rotation 3a. Conversely, a rotation of the selector lever 4 about its axis of rotation 3a brings about an axial movement of the second piston 12.

In addition, the actuator 10 includes a bistable locking device (not shown here in greater detail) for its first piston 11. The locking device is arranged, for example, within the first housing part 161 of the actuator housing 10a, centrally within the first piston 11, for example. The locking device is electromagnetically actuatable by an electromagnet (not shown here), which is arranged in the second housing part 162 of the actuator housing 10a. The locking device mechanically fixes the first piston 11 in an axial direction X either in a first piston position, which is associated with the engaged state P_ein of the parking lock device 100, or in a second piston position, which is associated with the disengaged state P_aus of the parking lock device 100, when the electromagnet (not shown here) is not energized. In order to be able to axially move the first piston 11, the electromagnet must therefore be energized in order to release the interlock of the locking device. In the second piston position of the second piston 12, the second piston 12 rests with its end face 12d against an internal stop surface 161b of the first housing part 161.

An armature rod (not shown here) of the electromagnet acts on latching elements (not shown here), where the latching elements, for example, are balls. In the locked state of the first piston 11, these locking elements are supported axially and radially against a support surface (not shown here) of the first piston 11.

In order to be able to hydraulically disengage the parking lock device 100 during normal operation while ensuring supply to the actuator 10, the actuator 10 has a pressure chamber (not shown here), to which pressure medium or hydraulic fluid is supplied via a pressure connection (not shown in greater detail). In the engagement position P_ein of the parking lock device 100, the pressure chamber (not shown here) is evacuated and the two pistons 11, 12 of the actuator 10 are located in their first end positions or first axial piston positions, in which the pistons 11, 12 are moved towards the electromagnet. The first piston 11 is mechanically fixed, i.e., locked in position, by the locking device against moving axially and the electromagnet is de-energized.

A failure of the control of the actuator 10 in the disengaged state P_aus of the parking lock device 100 is not a problem, since the parking lock cannot independently change its engagement position due to the fact that the first piston 11 is still mechanically locked in position.

If the control of the actuator 10 fails in the engaged state P_ein of the parking lock device 100 and if the locking device (not shown here) is still activated, the parking lock device 100 is no longer disengageable to the desired extent. The emergency actuation device 19 is provided for use in the case of such functional failures, by which the parking lock device 100 is also manually disengageable without the above-described actuation of the actuator 10.

The actuator concept which includes the two pistons 11, 12 allows for a manually operable emergency actuation device 19 despite the presence of a bistable locking of the pressure-loadable first piston 11 of the actuator 10. By the emergency actuation device 19, the parking lock device 100 is mechanically transferrable from the engagement position P_ein into the engagement position P_aus in the event of failure of the hydraulic and/or electric control of the actuator 10. For this purpose, the emergency actuation device 19 is mechanically bringable into an operative connection with the second piston 12 in the region of a driving part 12e, which is a pin in the present case. In the exemplary embodiment of the parking lock device 100 shown here, the emergency actuation device 19 includes an outer lever 19a, which is outside of the transmission housing of the automatic transmission and is not shown in greater detail in the drawing, and a control lever 19b, which is arranged in the interior space of the transmission housing. The control lever 19b is also referred to in the following as an inner lever and is connected to the outer lever 19a for conjoint rotation via a pin 19d, which penetrates or extends from outside into the transmission housing. The inner lever 19b has a limb 19c, where the limb 19c mechanically acts directly on the pin 12e when the emergency actuation device 19 is actuated. Due to the actuation or rotation of the inner lever 19b in a direction of rotation DR1, the second piston 12 is moved in an axial direction X and, simultaneously, the selector lever 4 is rotated about its axis of rotation 3a in the direction of rotation intended for disengaging the parking lock device 100. When the emergency actuation device 19 is actuated, the second piston 12 of the actuator 10 is axially displaced by the inner lever 19b, without the first piston 11 of the actuator 10 leaving its piston position corresponding to the engaged state P_ein of the parking lock device 100. Furthermore, the emergency actuation device 19 has a housing-side stop 19f for the control lever 19b in the non-actuated state.

In other words, a manual actuation of the emergency actuation device 19 initiates a pivoting of the inner lever 19b of the emergency actuation device 19 in the direction of rotation DR1, the inner lever being connected to the outer lever for conjoint rotation. During this pivoting, the limb 19c of the inner lever 19a presses on the pin 12e, which is fixedly connected to the piston rod 12c of the second piston 12, and moves the second piston 12 in an axial direction X into its second piston position. The blocking element 6 is also pulled via the connecting rod 5 out of its blocking position, as is the case during normal operation of the parking lock device 100, and the parking lock device 100 is disengaged. The first piston 11 of the actuator 10, which is still locked in an axial direction by the activated locking device (not shown here), remains in its first piston position. The parking lock device 100 is now in the emergency-released operating state.

If the actuation of the emergency actuation device 19 in the emergency-released operating state of the parking lock device 100 is terminated, the inner lever 19b of the emergency actuation device 19 pivots back into its start position due to the restoring force of a torsion spring 19e, which is provided here, for example. As a result, the second piston 12 is displaced by the spring 9 towards its first piston position and the engagement of the parking lock device 100 is again initiated.

A “regular” pivoting of the selector lever 4 during normal operation—i.e., with a fully operable actuator 10—has no mechanical effect whatsoever on the inner lever 19b and the outer lever 19a of the emergency release device 19.

With regard to the above-described mode of operation of the parking lock device 100, it is possible that the second piston 12 is transferred by the spring 9, in a substantially unbraked manner, from its second piston position into its first piston position both during normal operation, in which the actuator 10 is actuatable hydraulically and electrically with a full range of functions, and upon leaving the emergency-released operating state of the parking lock device 100, where the parking lock device 100 was manually disengaged against the spring force of the spring 9 via the emergency release device 19.

This is the case during normal operation of the parking lock device 100 when the pressure chamber (not shown here) is not sufficiently filled with pressure medium and the interlock of the locking device (not shown here) in the disengaged operating state of the parking lock device 100 is deactivated by energizing the electromagnet (not shown here). Thereupon, the spring 9 transfers both pistons 11, 12 from the second piston positions, in an unbraked manner, towards the first piston positions.

If the actuation of the emergency release device 19 is terminated, the spring 9 guides the second piston 12 out of its second piston position towards its first position, without a substantial force counteracting this actuating motion.

The parking lock device 100 includes a transmission-internal stop concept in the region of the emergency actuation device 19 in order to also prevent damage to load-carrying regions of the actuator 10, i.e., the pin 12e of the pistons 11, 12, the piston guide or the housing 10a, in the event of misuse or a misactuation of the emergency release device 19.

A high level of effectiveness with respect to the impact of tolerance and loads is achieved when an actuation-travel-limiting unit is spaced as far apart as possible from the axis of rotation of the control lever 19b. In addition, such a stop concept, which is able to be integrated into the existing parts inventory of the parking lock device 100, brings about a larger actuation range of the emergency actuation device.

A larger actuation range makes it possible to easily cover a greater range of functions. Within such an actuation range of the emergency actuation device 19, it should be functionally ensured, on the one hand, that the parking lock device 100 is reliably mechanically released and, on the other hand, that the parking lock device 100 is also reliably transferred into the disengaged operating state P_aus and this is also detected by a position sensor of the parking lock device 100 in a manner which is reliable with respect to the operating state. This is necessary, since the disengaged operating state is generally the precondition for an engine start.

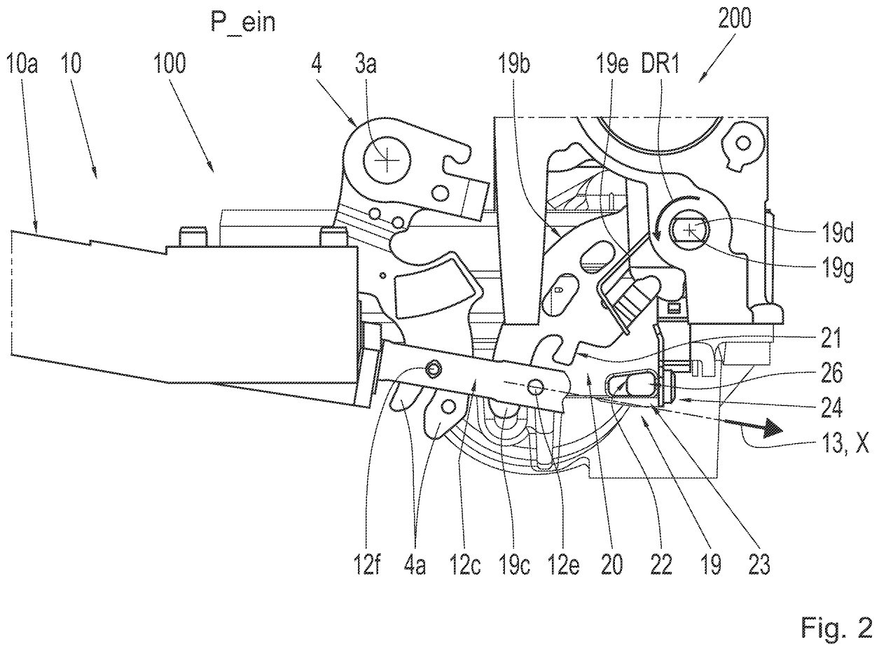

FIG. 2 through FIG. 32 show various embodiments of the further transmission-internal stop concept. By the “further stop concept,” the actuation travel of the second piston 12 is limited during an actuation of the second piston 12 by the emergency actuation device 19 from the first piston position towards the second piston position. The emergency actuation device 19 has an actuation-travel-limiting unit 20 for this purpose.

FIG. 2 through FIG. 5 show various views of a first embodiment of the actuation-travel-limiting unit 20, which is defined by a contact area 21 of the control lever 19b and a stop surface 22 on a housing 23 of a hydraulic transmission control unit 24, the stop surface 22 interacting with the contact area 21. Particularly, the contact area 21 of the control lever 19b rests against the stop surface 22 in the second piston position of the second piston 12 in order to prevent a rotational motion of the control lever 19b to position associated with an axial actuating motion of the second piston 12 beyond the second piston position. As a result, in the event of a misactuation of the second piston 12 by the emergency actuation device 19, the second piston 12 is prevented from impacting, via its end face 12d (FIG. 1), the inner side or the inside stop surface 161b (FIG. 1) of the housing part 161 (FIG. 1) and the introduction of an undesirably high impulse into the housing 10a, the second piston 12, the pin 12e and the control lever 19b is prevented, which impulse adversely affects the mode of operation of the parking lock device 100.

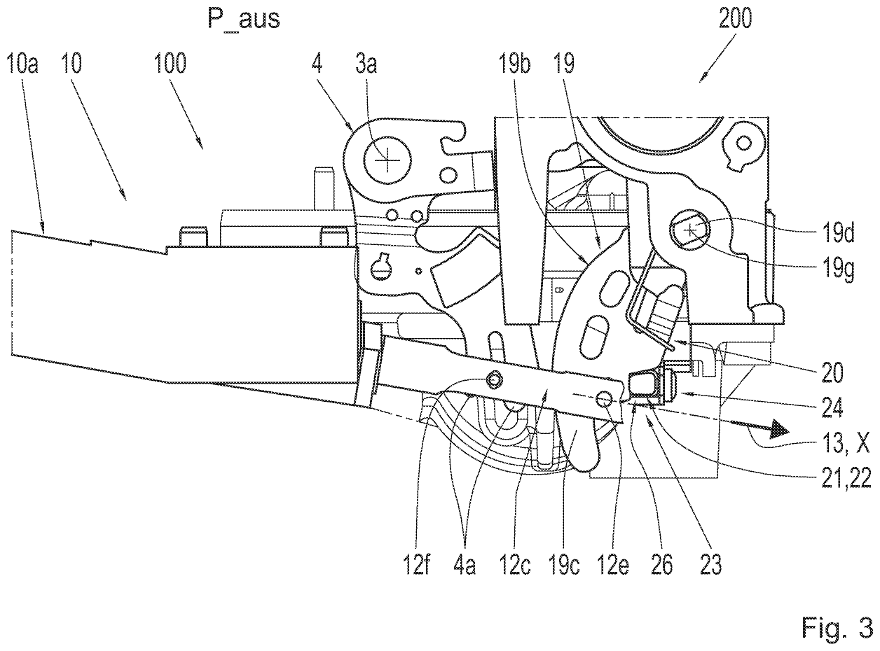

FIG. 2 shows the emergency actuation device 19 in the non-actuated operating state and the parking lock device 100 in the engaged state P_ein. In contrast thereto, the emergency actuation device 19 in FIG. 3 is shown in the actuated state, in which the parking lock device 100 has been transferred by the control lever 19b into the disengaged operating state P_aus. In the actuated state of the emergency actuation device 19 in FIG. 3, the control lever 19b rests with its contact area 21 against the stop surface 22 and limits the actuation travel of the second piston 12 in an axial direction X.

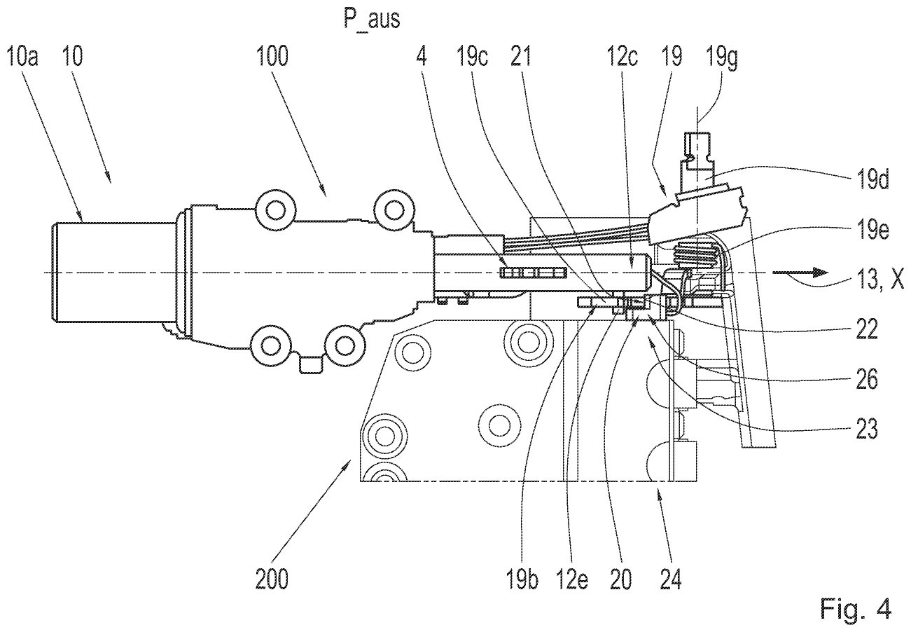

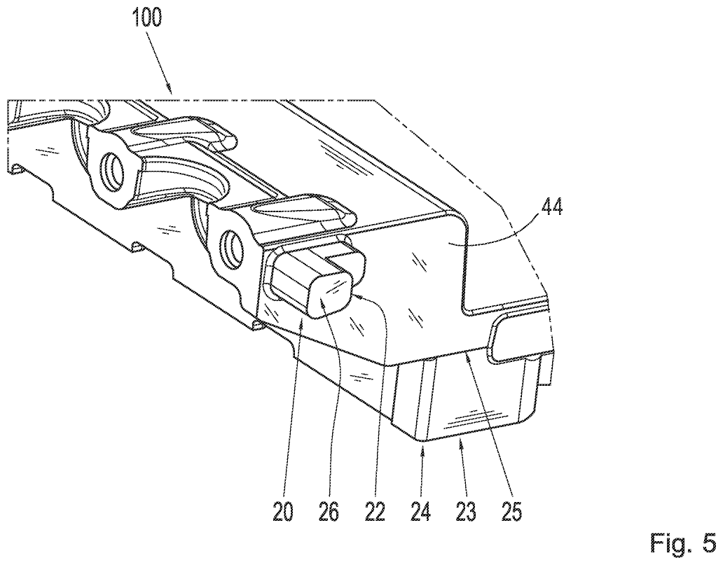

As is apparent from FIG. 4, the contact area 21 of the control lever 19b and the stop surface 22 lie in the plane of rotation of the control lever 19b. In addition, it is apparent in FIG. 5 that the stop surface 22 is provided on an outer side of the housing 23 of the transmission control unit 24 and outside a parting plane 25 of the housing 23. The stop surface 22 is a lateral face of a region 26, which is cast onto the outer side 44 of the housing 23 and which has an at least approximately cuboid shape.

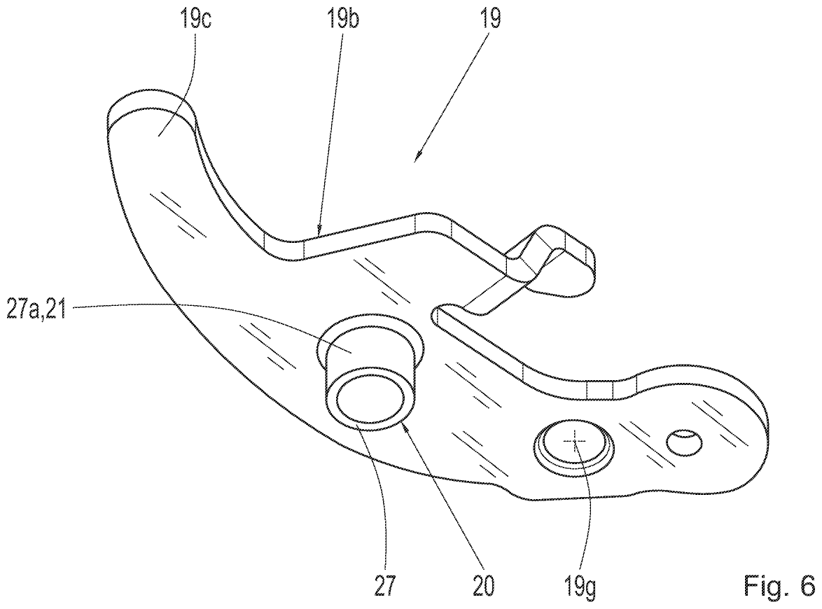

FIG. 6 through FIG. 10 show various views of one further embodiment of the parking lock device 100. The emergency actuation device 19 of the parking lock device 100 structurally deviates in some areas from the emergency actuation device 19 of the parking lock device 100 according to FIG. 2 through FIG. 5 and otherwise has the range of functions described in greater detail with respect to FIG. 1. For this reason, essentially only the differences between the parking lock devices 100 according to FIG. 2 through FIG. 5 and according to FIG. 6 through FIG. 10 are described in greater detail in the following.

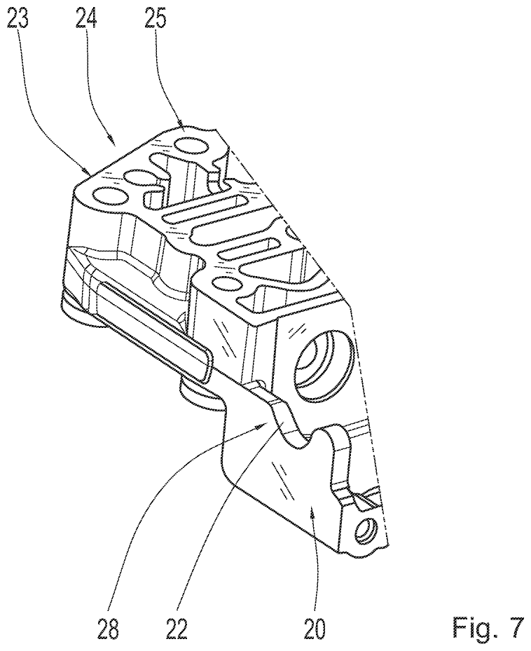

FIG. 6 shows an embodiment of the control lever 19b, where the control lever 19b is fixedly connected to a hollow cylindrical sleeve 27 in a region spaced apart from the axis of rotation 19g of the control lever 19b, and where the control lever 19b is a stamped and bent sheet-metal part. An outer side 27a of the hollow cylindrical sleeve 27 defines, in the present case, the contact area 21 of the actuation-travel-limiting unit 20 of the parking lock device 100 according to FIG. 6 through FIG. 10. Furthermore, in a manner shown in greater detail in FIG. 7, the stop surface 22 of the actuation-travel-limiting unit 20 of the parking lock device 100 is defined in a trough-like region 28 of the housing 23 of the transmission control unit 24. The curvature of the trough-like region 28 is adapted to the curvature of the outer side 27a of the sleeve 27.

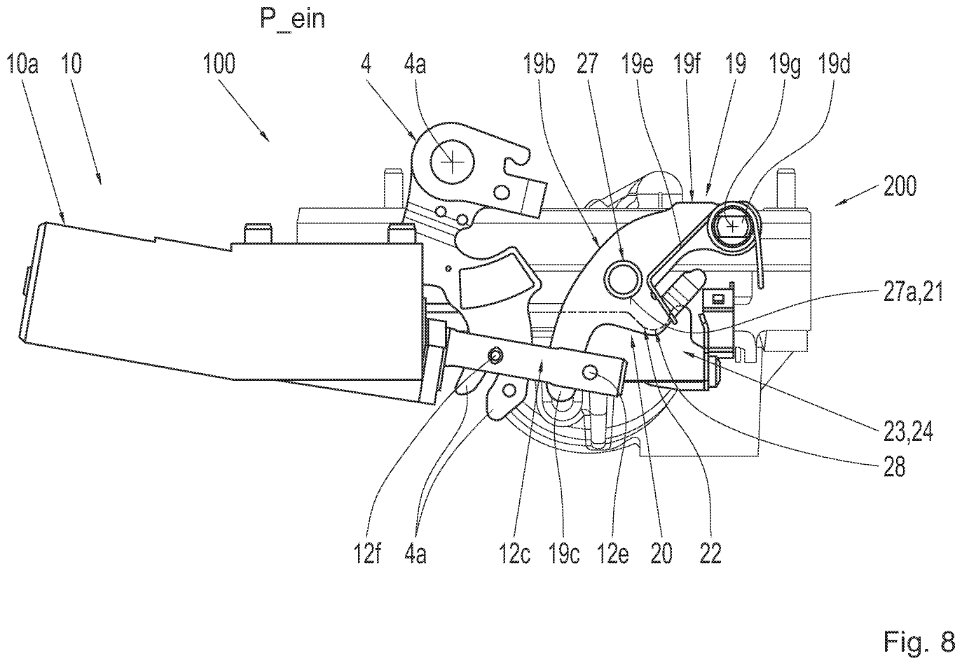

In the operating state of the parking lock device 100 shown in greater detail in FIG. 8, the parking lock device 100 is in the engaged operating state P_ein. At the same time, the control lever 19b is pivoted by the torsion spring 19e completely into the rotation position which corresponds to the unactuated position of the emergency actuation device 19. In this operating state of the emergency actuation device 19, the limb 19c of the control lever 19b does not rest against the pin 12e. As is apparent in FIG. 8, the sleeve 27 is also arranged outside the trough-like region 28 in this operating state of the emergency actuation device 19.

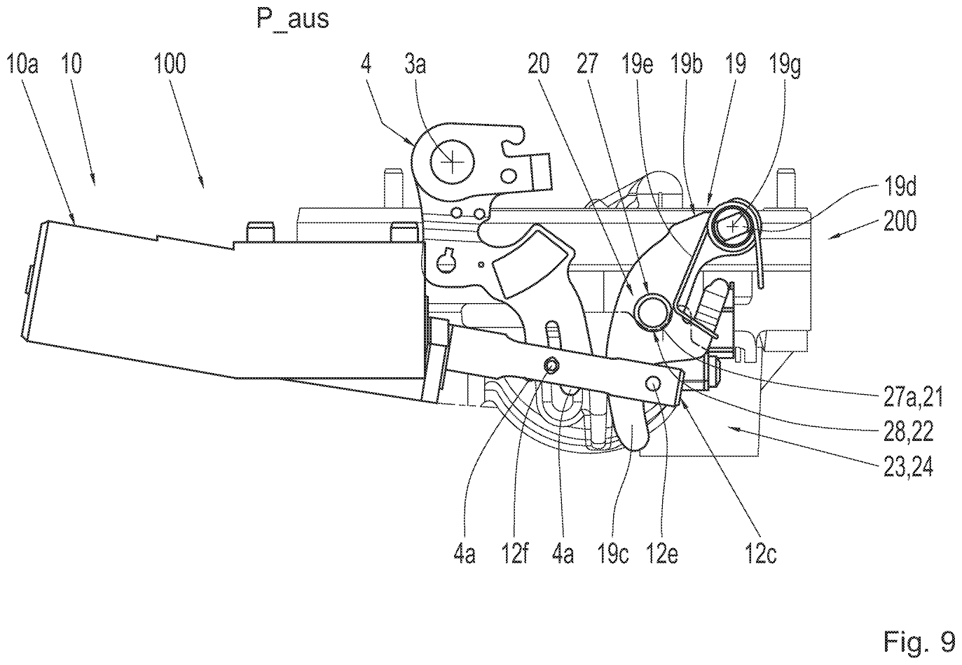

If the control lever 19b of the emergency actuation device 19 is moved manually by an operator against the spring force of the torsion spring 19e from the rotation position shown in FIG. 8 into the position shown in FIG. 9 in order to transfer the parking lock device 100 into the disengaged operating state P_aus, the control lever 19b initially comes to rest with the limb 19c against the pin 12e. The second piston 12 is then pulled in the axial direction X (FIG. 1) against the spring force of the spring 9 out of the housing 10a of the actuator 10 until the hollow cylindrical sleeve 27 rests with its outer side 27a against the stop surface 22 of the trough-like region 28 in the manner shown in greater detail in FIG. 9. The rotation angle of the control lever 19b and the corresponding axial actuation travel of the second piston 12 are matched to each other such that the second piston 12 comes to rest with its end face 12d precisely against the inner-side stop surface 161b (FIG. 1) of the housing part 161 or is still spaced apart therefrom. As a result, it is ensured that an impact of the second piston 12 against the housing part 161 (FIG. 1) due to the emergency actuation of the parking lock device 100, which adversely affects the mode of operation of the parking lock device 100, is prevented.

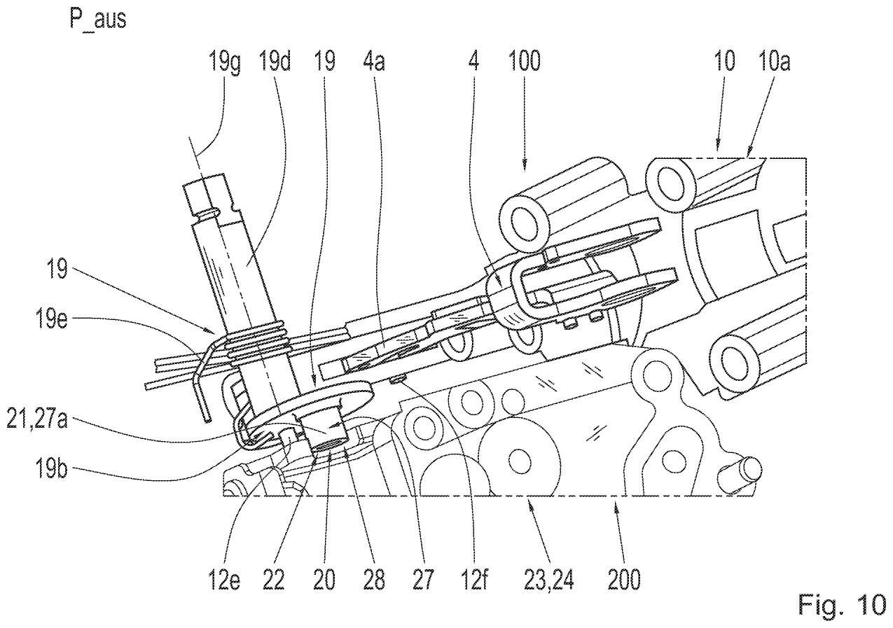

FIG. 10 shows a three-dimensional or “perspective” view obliquely from above of the parking lock device 100. It is apparent from the view according to FIG. 10 that the contact area 21 of the control lever 19b and the stop surface 22 are offset with respect to the plane of rotation of the control lever 19b in an axial direction of the bolt 19d and also of the control lever 19b.

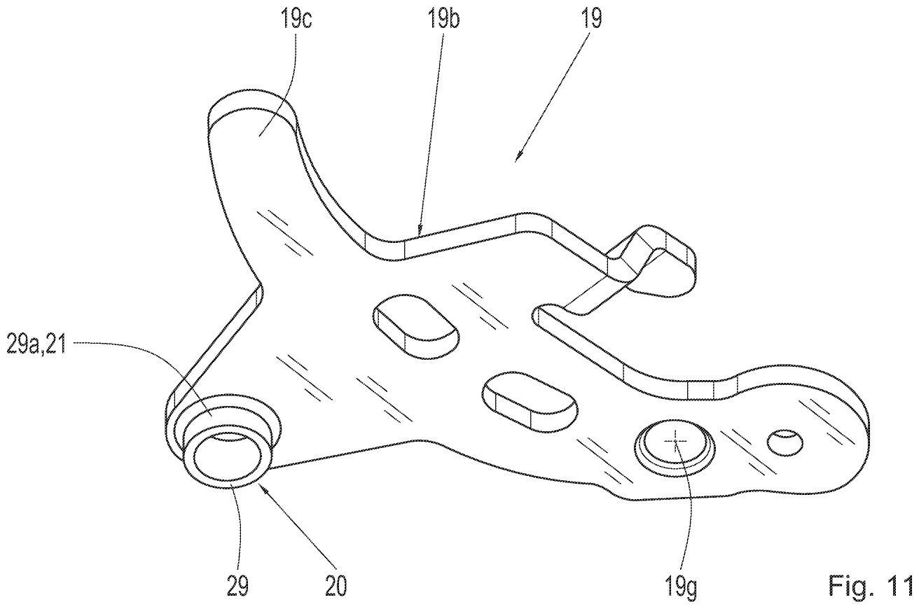

FIG. 11 shows a view similar to FIG. 6 of one further embodiment of the control lever 19b, where the control lever 19b in FIG. 11 is fixedly connected to a hollow cylindrical sleeve 29. The sleeve 29 has a shorter axial height, however, than the sleeve 27 of the control lever 19b according to FIG. 6.

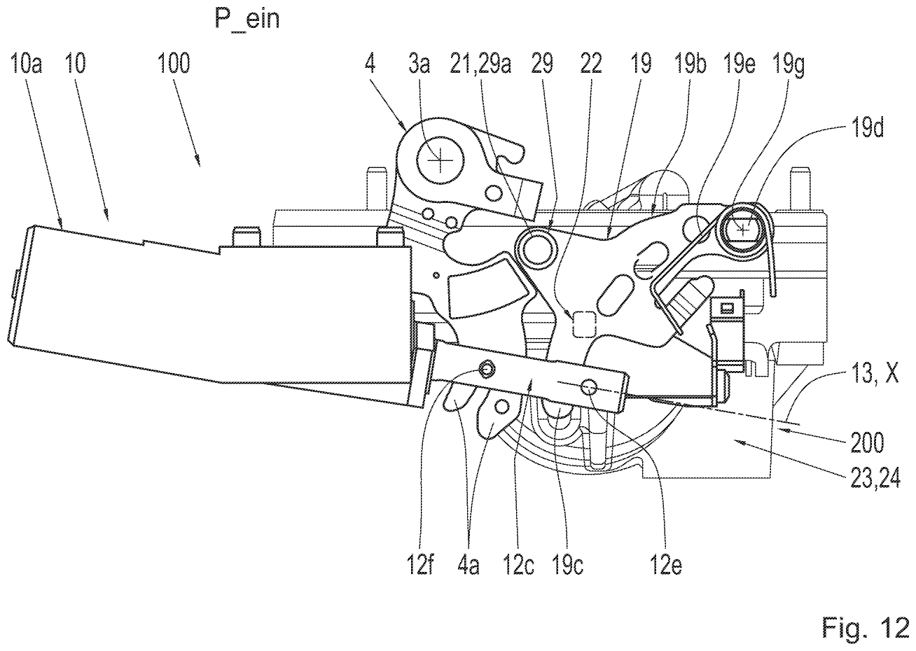

As shown in FIG. 12, the hollow cylindrical sleeve 29 is spaced apart from the stop surface 22 of the actuation-travel-limiting unit 20 in the unactuated state of the emergency actuation device 19 and in the engaged operating state P_ein of the parking lock device 100.

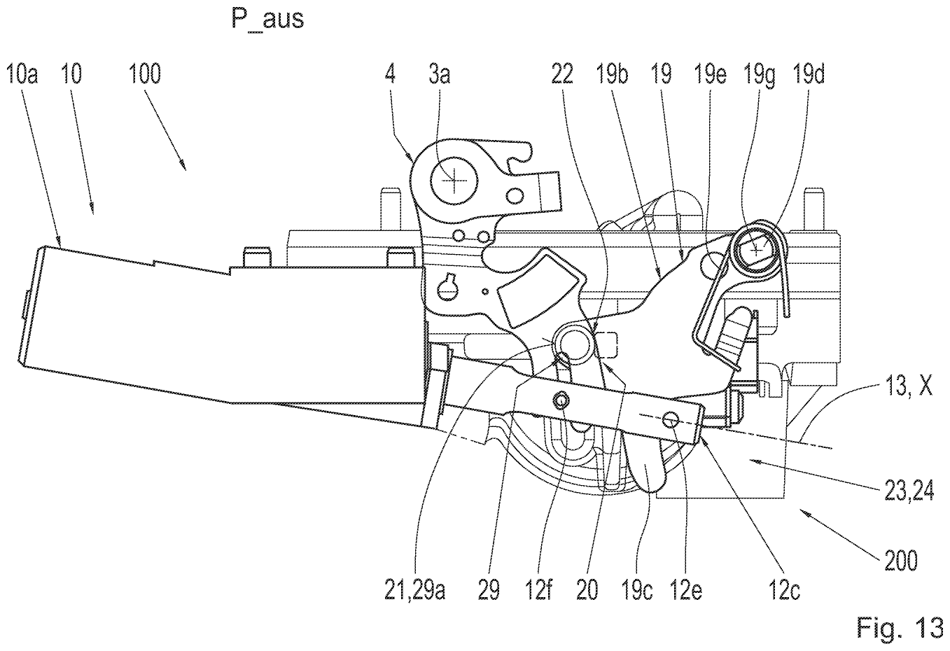

The emergency actuation device 19 corresponding to FIG. 12 is shown in the actuated state in FIG. 13. The control lever 19b rests with the limb 19c against the pin 12e and the parking lock device 100 is disengaged. The outer side 29a or the stop surface 22 of the hollow cylindrical sleeve 29 rests laterally against the stop surface 22, which extends substantially in the vertical direction in the installed position of the automatic transmission 200.

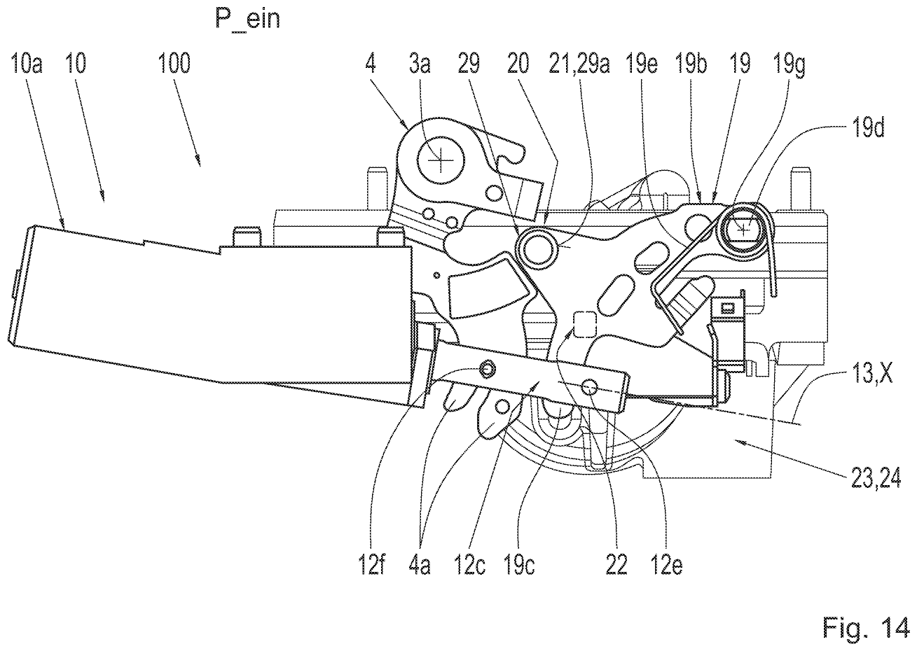

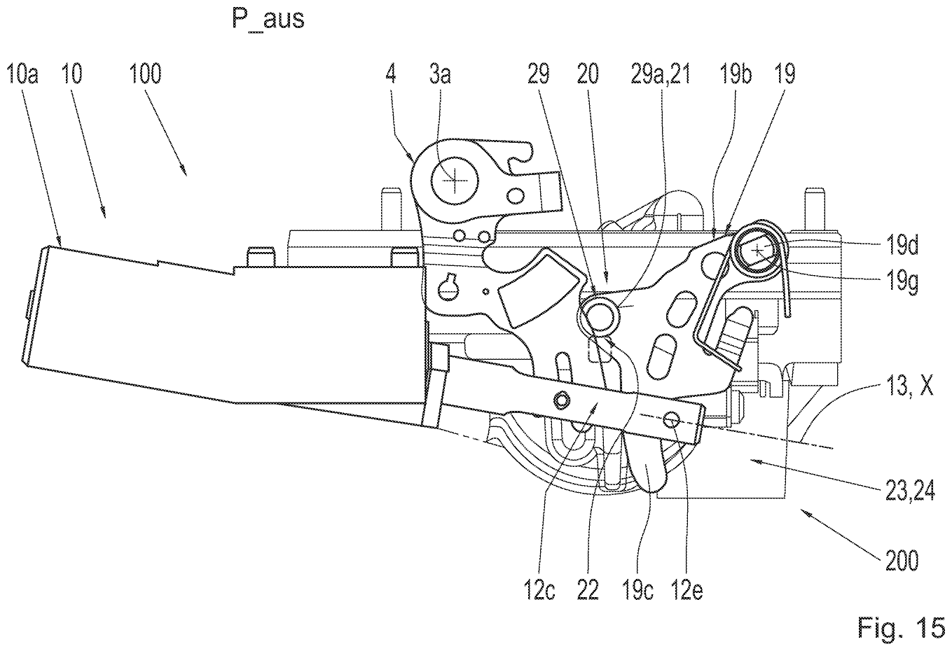

In contrast thereto, the stop surface 22 of the actuation-travel-limiting unit 20 of the parking lock device 100 according to FIG. 14 and FIG. 15 is oriented substantially in the horizontal direction in the installed position of the automatic transmission 200. For instance, in FIG. 15, the hollow cylindrical sleeve 29 of the control lever 19b according to FIGS. 14 and 15 rests from above on the stop surface 22 of the actuation-travel-limiting unit 20 in the actuated state of the emergency actuation device 19.

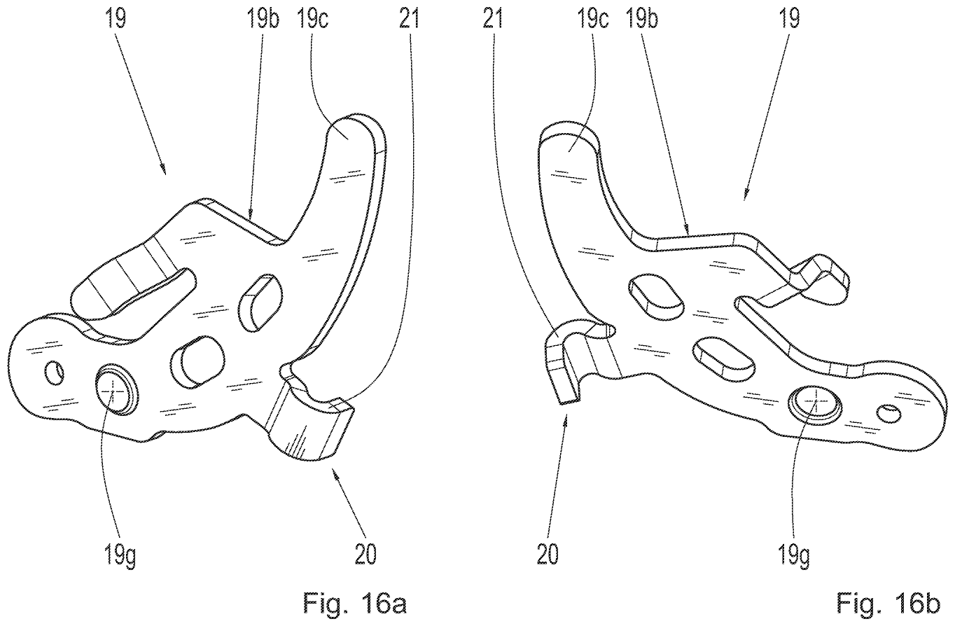

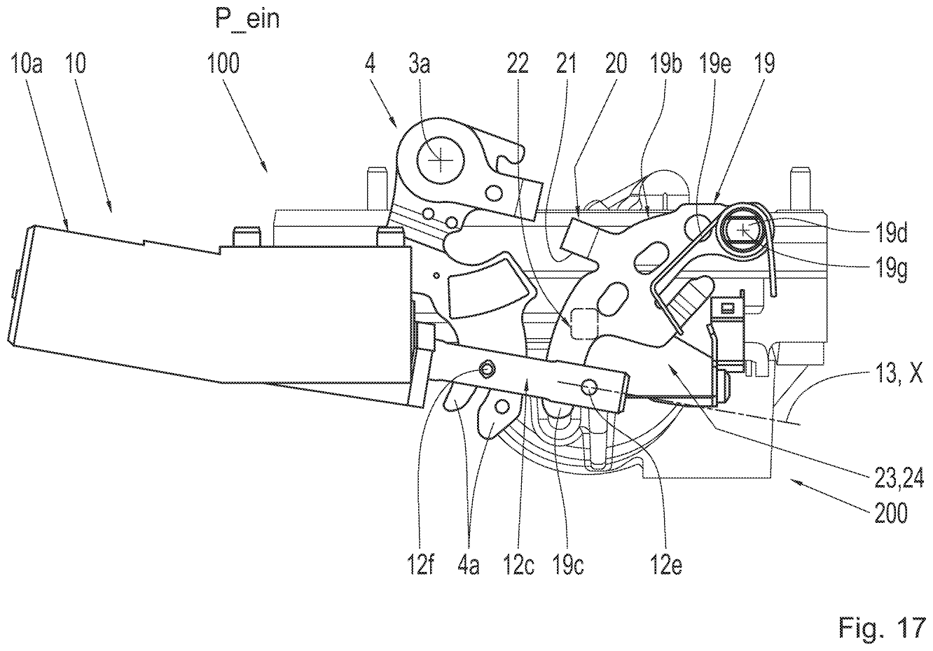

FIG. 16a and FIG. 16b show one further embodiment of the control lever 19b, which is also a stamped and bent sheet-metal part and, in the contact area 21, defines a bent shape for enlarging the stop surface. In FIG. 17, the control lever 19b is shown in the rotation position which corresponds to the unactuated operating state of the emergency actuation device 19. The parking lock device 100 is in the engaged operating state P_ein. The contact area 21 is spaced apart from the horizontally oriented stop surface 22.

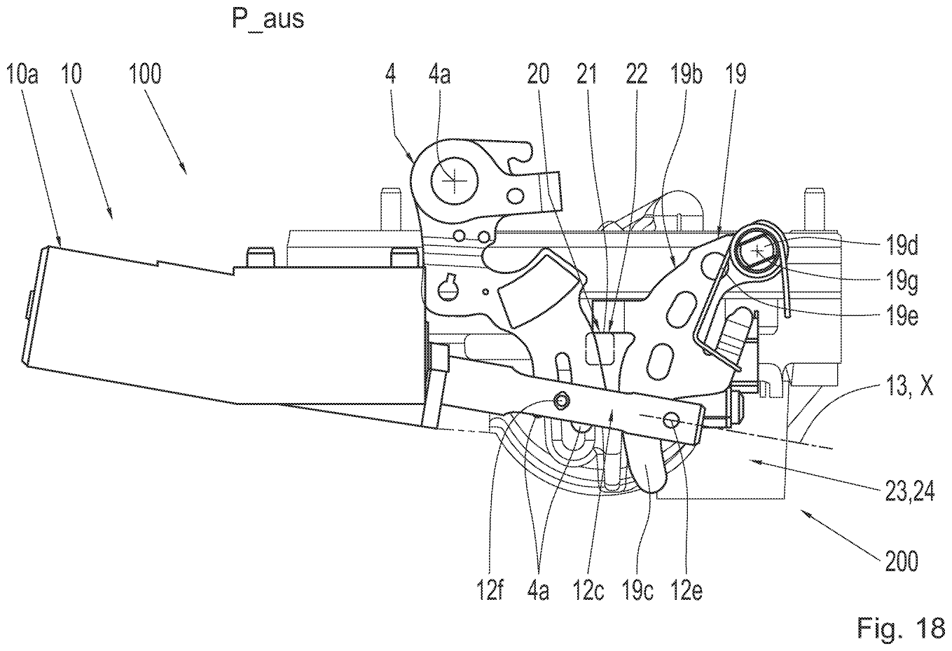

FIG. 18 shows the emergency actuation device 19 in the actuated state, in which the parking lock device 100 has been transferred by the control lever 19b into the disengaged operating state P_aus. The control lever 19b in FIG. 18 is shown in a rotation position in which the control lever 19b rests with the bent contact area 21 from above on the stop surface 22 of the actuation-travel-limiting unit 20 and thereby limits a rotational motion of the control lever 19b in the direction of rotation DR1 and an actuating motion of the second piston 12 in an axial direction X of the actuator 10 beyond the second piston position.

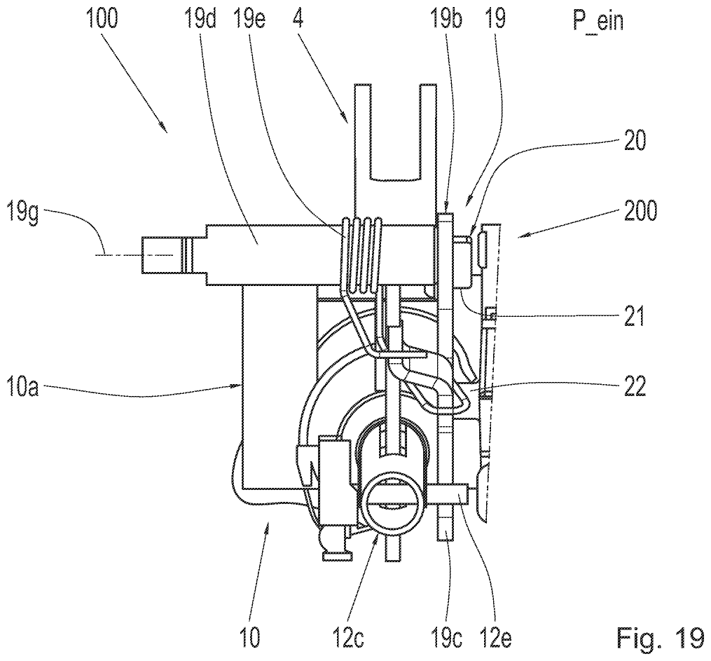

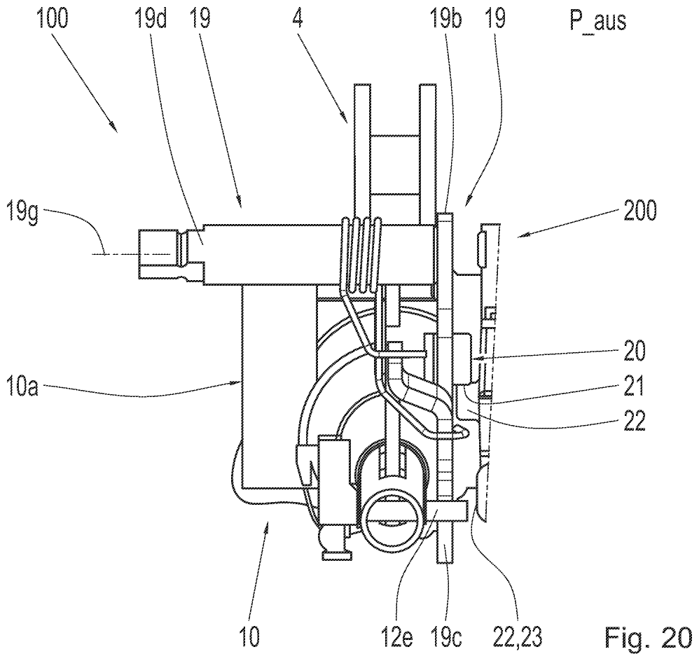

FIG. 19 and FIG. 20 show the parking lock device 100 and the emergency actuation device 19 in a rear view in each case, the emergency actuation device 19 in FIG. 19 being shown in the unactuated operating state, while FIG. 20 graphically shows the emergency actuation device 19 in the actuating state.

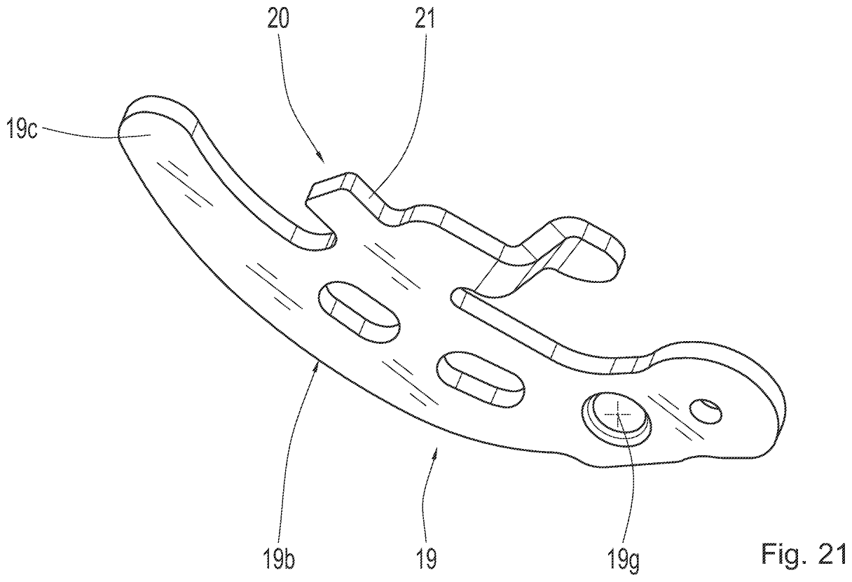

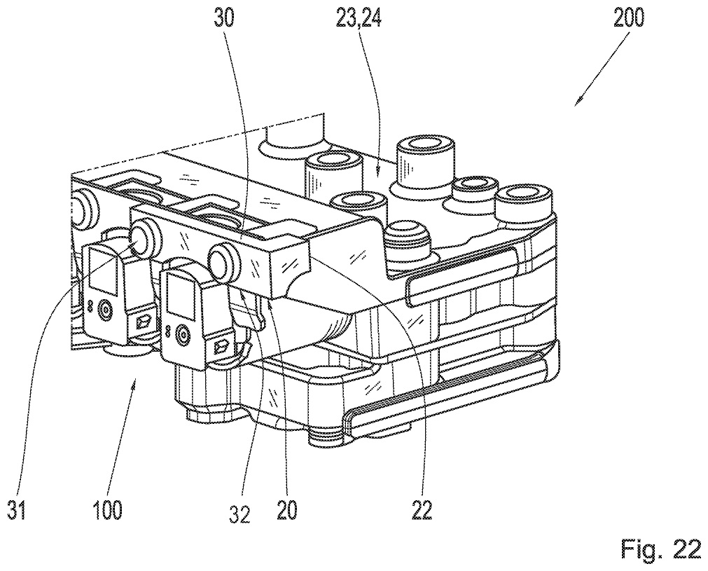

FIG. 21 shows one further embodiment of the control lever 19b, which is also a stamped and bent sheet-metal part. The contact area 21 of the control lever 19b according to FIG. 21 lies in the plane of rotation of the control lever 19b and is bringable into an operative connection with a stop surface 22 of an L-shaped component 30, as shown in FIG. 22, in order to limit the actuation travel of the second piston 12 towards its second piston position. The L-shaped component 30 is a screw-on part, which in the present case, is screwed on the housing 23 of the hydraulic transmission control unit 24 via two screw connections 31, 32 in the manner shown in greater detail in FIG. 22.

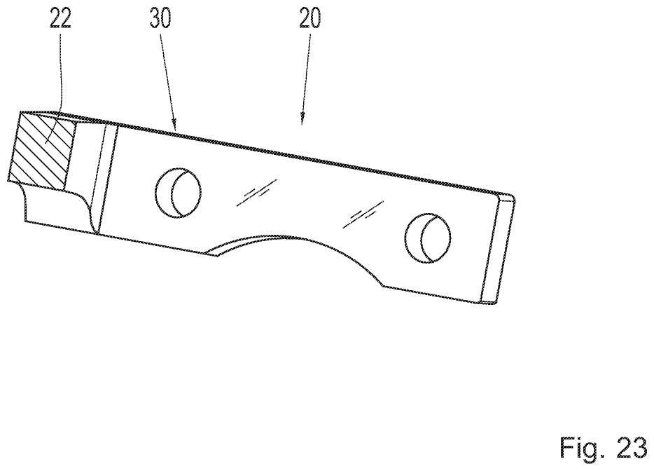

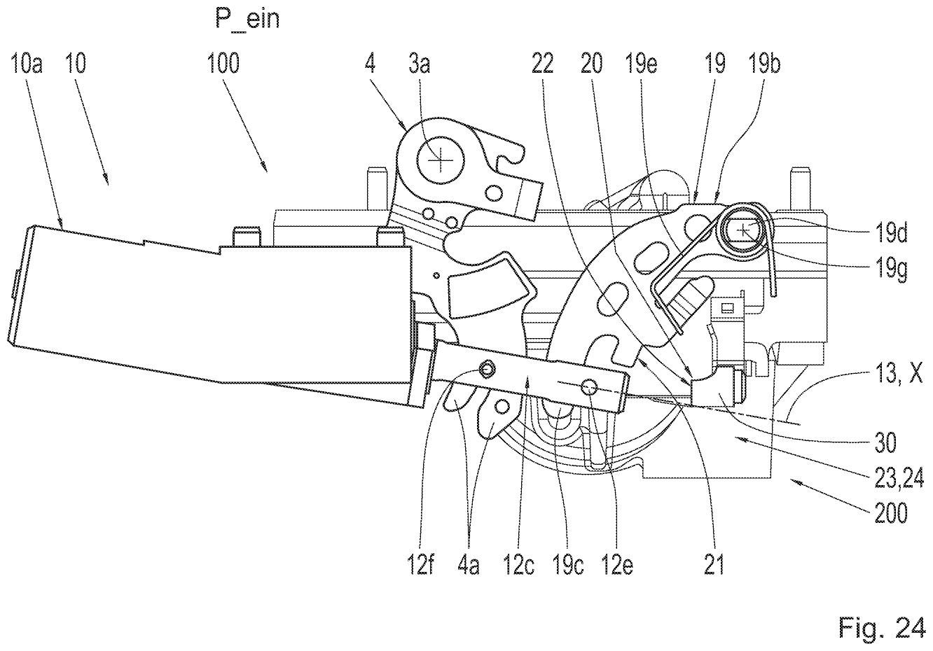

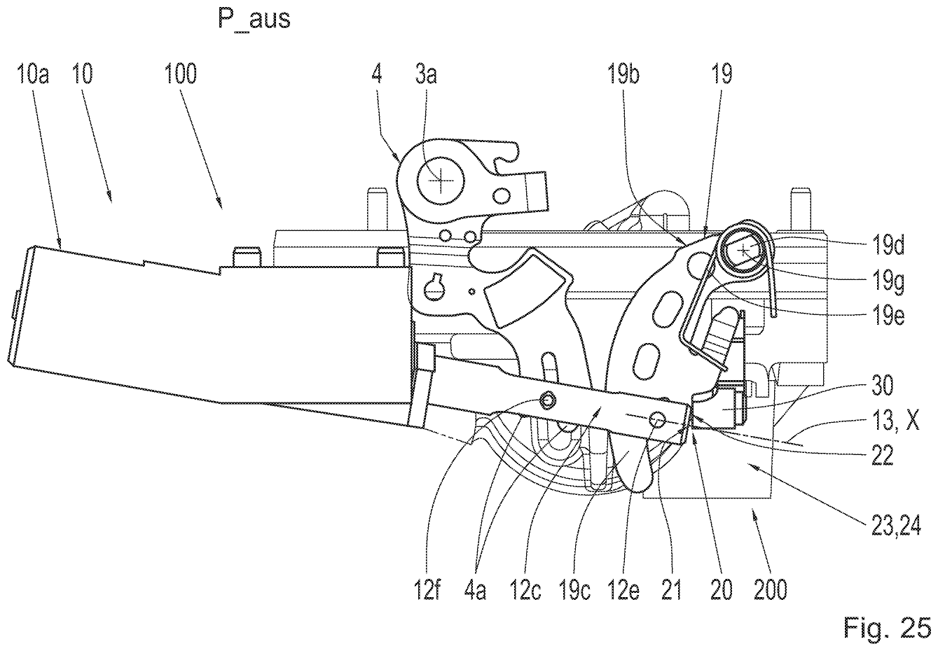

FIG. 23 shows the L-shaped component 30 in a three-dimensional component drawing, while FIG. 24 shows the parking lock device 100 in a side view. The parking lock device 100 in FIG. 24 has the L-shaped component 30 of FIG. 23 and is in the engaged operating state P_ein. In addition, FIG. 24 shows the emergency actuation device 19 in the unactuated state, whereas the parking lock device 100 in FIG. 25 is shown in the disengaged operating state P_aus and the emergency actuation device 19 is shown in the actuated state.

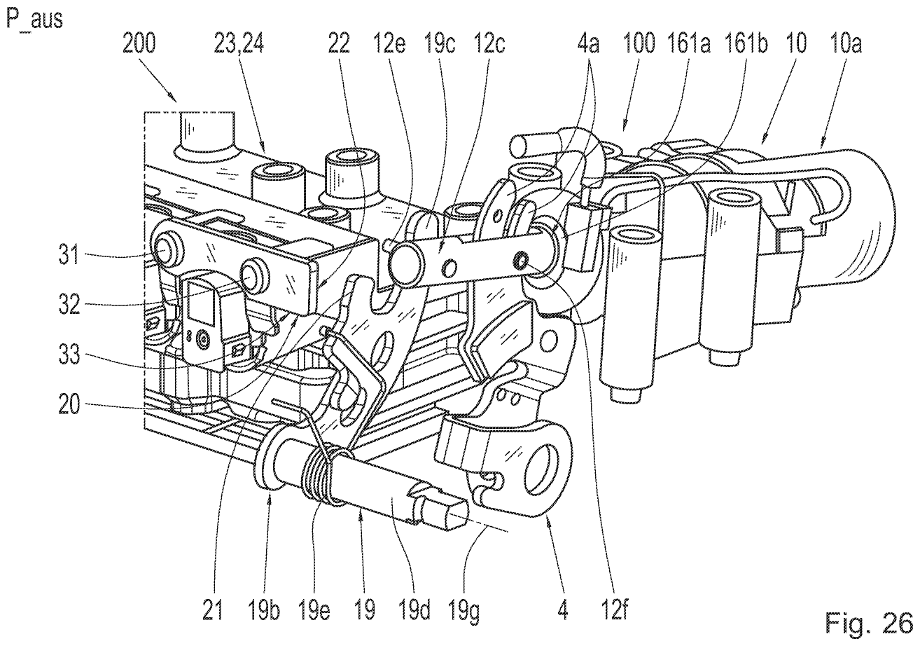

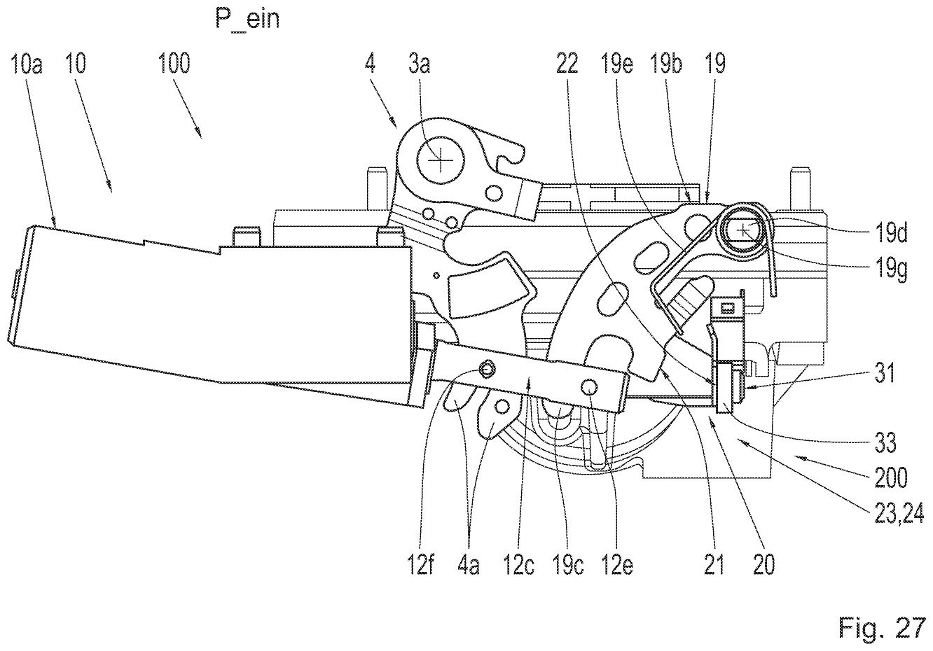

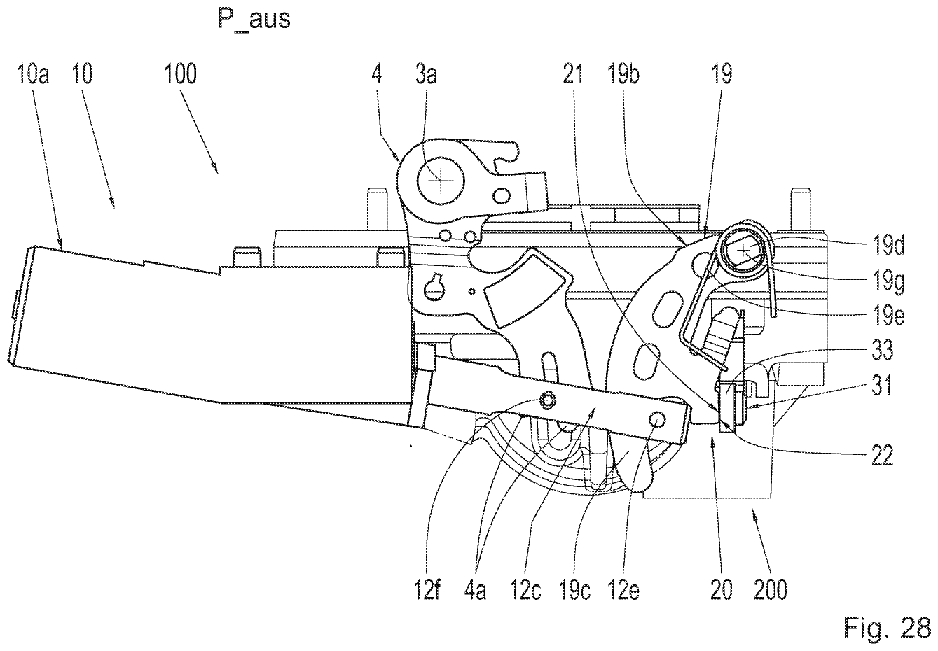

FIG. 26 shows a three-dimensional partial view of one further embodiment of the parking lock device 100, which has a flat bar 33. The flat bar 33 is also a screw-on component and is fixedly connected to the housing 23 of the transmission control unit 24 via two screw connections 31, 32. The flat bar 33 laterally protrudes beyond the housing 23, the overhanging end region of the flat bar 33 forming the stop surface 22 of the actuation-travel-limiting unit 20 on the side facing the housing 23. The control lever 19b in FIG. 26 is as shown in FIG. 21, and is spaced apart with its contact area 21 from the stop surface 22 of the flat bar 33 as the emergency actuation device 19 is not activated. FIG. 27 shows a side view of the parking lock device 100 according to FIG. 26. In the side view of the parking lock device 100 of FIG. 26 shown in FIG. 28, the parking lock device 100 is shown in the disengaged state P_aus, with the second piston 12 being held in its second piston position by the control lever 19b, and the control lever 19b rests with its contact area 21 against the stop surface 22 of the flat bar 33.

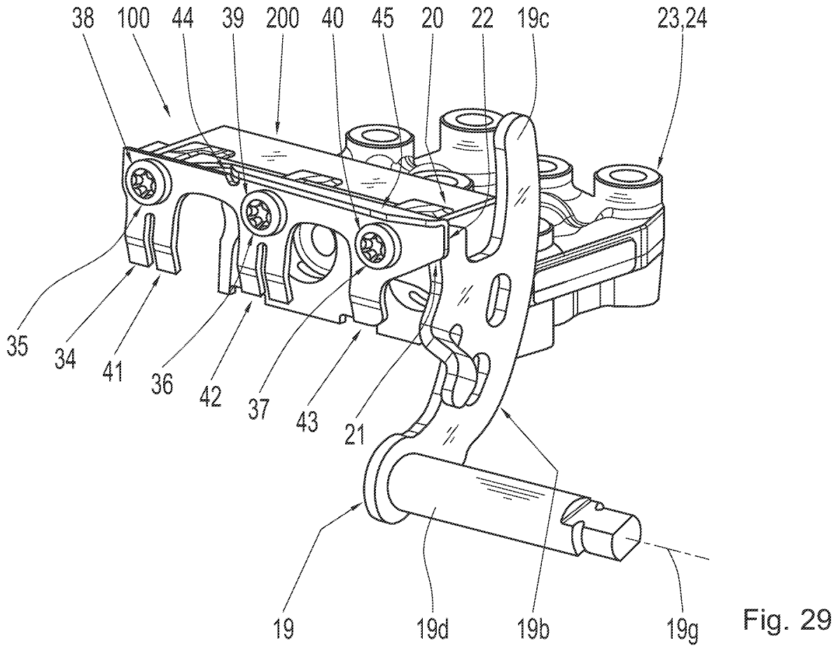

FIG. 29 through FIG. 32 show one further embodiment of the parking lock device 100, which includes a flat mounting plate 34. The flat mounting plate 34 is also a screw-on part and is fixedly screwed onto the housing 23 of the transmission control unit 24 in the region of three screw connections 35, 36, 37. The flat mounting plate 34 laterally protrudes beyond the housing 23. The stop surface 22 of the actuation-travel-limiting unit 20 is a lateral face of the mounting plate 34 and faces the housing 23. The screw connections 35, 36, 37 extend through the flat mounting plate 34 in the region of multiple mutually spaced fastening regions 38, 39, 40. Multiple finger-like support regions 41, 42, 43 extend from the fastening regions 38, 39, 40. The flat mounting plate 34 additionally rests against the outer side 44 of the housing 23 via the support regions 41, 42, 43. The finger-like support regions 41, 42, 43 are bent between the fastening regions 38, 39, 40 and free ends of the support regions 41, 42, 43, such that the support regions 41, 42, 43, in the installed state of the mounting plate 34, rest against the housing 23 of the hydraulic transmission control unit 24 with preload on the outer side 44 of the housing 23.

In addition, the flat mounting plate 34 has a folded edge 45 which increases the component stiffness of the mounting plate 34, the folded edge 45 extends away from a top side of the mounting plate 34, above the fastening regions 38, 39, 40, on the side of the mounting plate 34 facing away from the housing 23, and substantially encloses a right angle with the finger-like support regions 41, 42, 43. The control lever 19b rests with its contact area 21 against the stop surface 22 of the flat mounting plate 34 in the rotation position shown in FIG. 29.

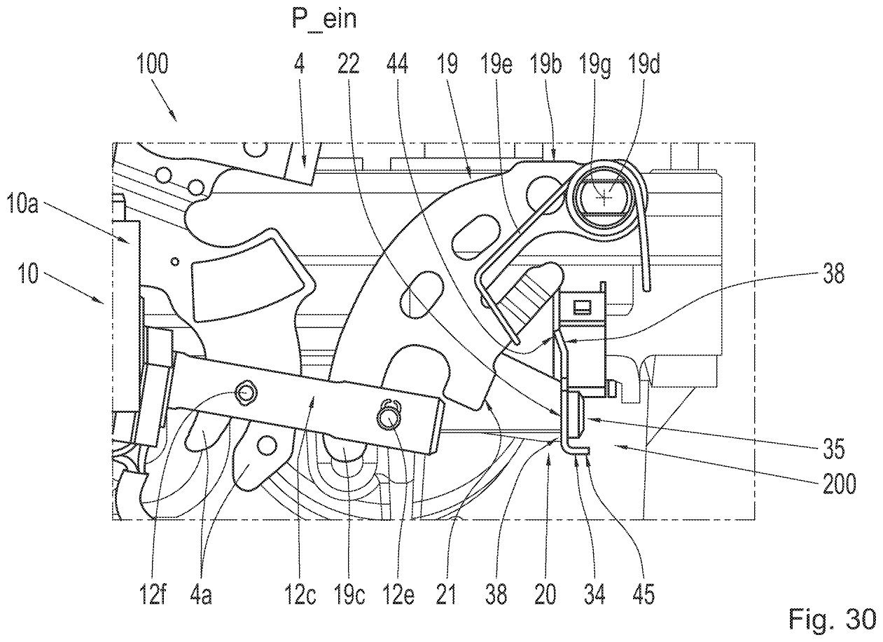

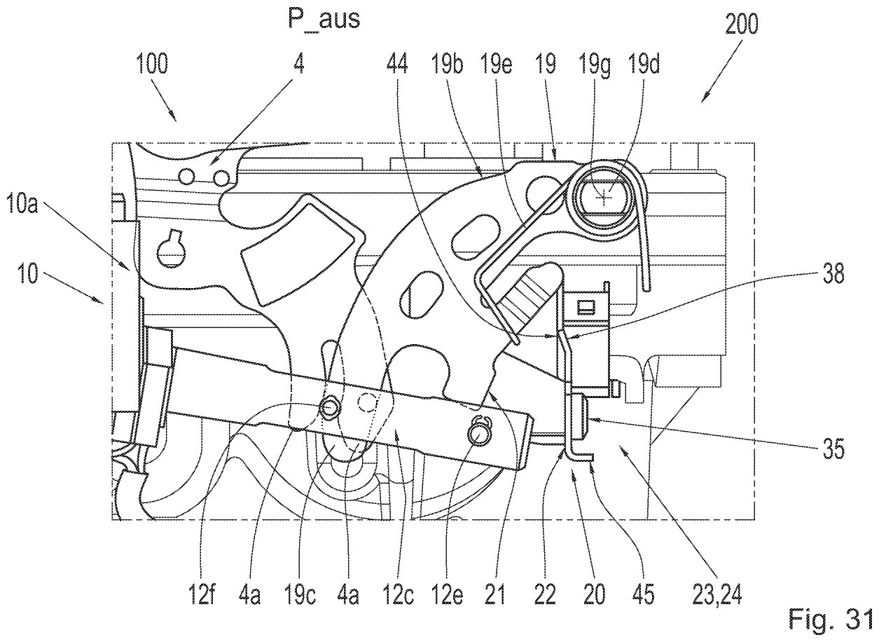

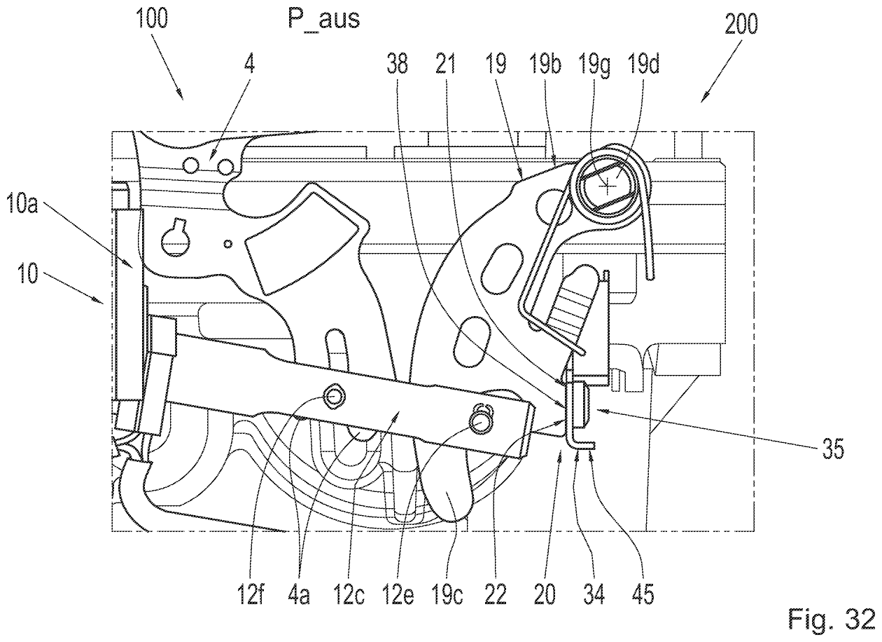

In contrast thereto, FIG. 30 and FIG. 31 show the emergency actuation device 19 of FIG. 29 in the unactuated state in each case. The parking lock device 100 is shown in the engaged state P_ein in FIG. 30 and in the disengaged state P_aus in FIG. 31. In addition, FIG. 32 shows the parking lock device 100 in the disengaged state and the emergency actuation device 19 in the actuated or activated state in which the control lever 19b rests with its contact area 21 against the stop surface 22 of the flat mounting plate 34 and holds the second piston 12 in its second piston position against the spring force of the spring 9 of the actuator 10.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

[symbol]

### REFERENCE CHARACTERS

1 parking interlock gear
1a tooth space in the locking toothing of the parking interlock gear
2 locking pawl
2a ratchet tooth of the locking pawl
3 pawl pin
3a pawl pin longitudinal axis; locking pawl pivot axis; selector-lever axis of rotation
4 selector lever
4a driving part of the selector lever
5 connecting rod
6 blocking element; blocking cone
7 spring element of the blocking element
8 guide plate
9 spring; engagement spring
10 actuator
10a housing of the actuator
11 first piston of the actuator
12 second piston of the actuator
12a first guide section of the second piston
12b guide section for engagement spring
12c piston rod of the second piston
12d end face of the second piston
12e pin of the emergency actuation device
12f pin
13 piston longitudinal axis
161 first housing part of the housing of the actuator
161a bore in the first housing part 161
161b inner-side stop surface of the first housing part 161
162 second housing part of the housing of the actuator
162a end face of the second housing part 162
19 emergency actuation device
19b control lever of the emergency actuation device
19c limb of the control lever
19d bolt of the emergency actuation device
19e torsion spring of the emergency actuation device
19f stop of the control lever
19g axis of rotation of the control lever 19b
20 actuation-travel-limiting unit
21 contact area
22 stop surface
23 housing
24 transmission control unit
25 parting plane of the housing of the transmission control unit
26 cuboid-shaped region of the housing 23
27 hollow cylindrical sleeve
27a outer side of the hollow cylindrical sleeve 27
28 trough-shaped region of the housing 23
29 hollow cylindrical sleeve
29a outer side of the hollow cylindrical sleeve 29
30 L-shaped component
31 screw connection
32 screw connection
33 flat bar
34 flat mounting plate
35 screw connection
36 screw connection
37 screw connection
38 fastening region
39 fastening region
40 fastening region
41 finger-like support region
42 finger-like support region
43 finger-like support region
44 outer side of the housing 23
45 folded edge of the mounting plate
100 parking lock device
200 automatic transmission
DR1 first direction of rotation of the control lever
P_aus disengaged state of the parking lock
P_ein engaged state of the parking lock
X axial direction of the actuator

1-15: (canceled)

16. A parking lock device (100) for an automatic transmission (200), the parking lock device (100) comprising:
an actuator (10), the actuator (10) being hydraulically or pneumatically controllable, the actuator (10) comprising:
an actuator housing (10a) defining an opening (161a); and
a piston (12) movable in an axial direction (X) within the actuator housing (10a) between a first piston position and a second piston position, the parking lock device (100) being in a first engagement position when the piston (12) is in the first piston position, the parking lock device (100) being in a second engagement position when the piston (12) is in the second piston position, a guide section (12a) of the piston (12) extending in the axial direction (X) through the opening (161a), a length of the piston (12) extending outside of the actuator housing (10a) being longer when the piston (12) is in the second piston position than when the piston (12) is in the first piston position;
an emergency actuation device (19) outside of the actuator housing (10a), the emergency actuation device (19) being operatively connectable with the piston (12) such that the piston (12) is movable by the emergency actuation device (19) from the first piston position into the second piston position; and
an actuation-travel-limiting unit (20), movement of the piston (12) by the emergency actuation device (19) being limited when the emergency actuation device (19) contacts the actuation-travel-limiting unit (20).

17. The parking lock device of claim 16, wherein the emergency actuation device (19) includes a control lever (19b) rotatably mounted on a housing (23) for rotation about an axis of rotation (19g), rotation of the control lever (19b) in a first direction of rotation (DR1) operatively connecting the control lever (19b) with a driving part (10d) of the piston (12) such that the piston (12) is movable towards the second piston position,
wherein the actuation-travel-limiting unit (20) defines a stop surface (22), a contact area (21) of the control lever (19b) resting against the stop surface (22) when the piston (12) is in the second piston position to prevent further rotation of the control lever (19b) in the first direction of rotation (DR1) and further movement of the piston (12) in the axial direction (X) beyond the second piston position.

18. The parking lock device of claim 17, wherein a perpendicular distance between the axis of rotation (19g) of the control lever (19b) and the contact area (21) of the control lever (19b) and a perpendicular distance between the axis of rotation (19g) of the control lever (19b) and the stop surface (22) are both greater than a predefined threshold value.

19. The parking lock device of claim 17, wherein the contact area (21) of the control lever (19b) and the stop surface (22) lie in a plane of rotation of the control lever (19b).

20. The parking lock device of claim 17, wherein the contact area (21) of the control lever (19b) and the stop surface (22) are offset along the axis of rotation (19g) of the control lever (19b) from a plane of rotation of the control lever (19b).

21. The parking lock device of claim 17, wherein the contact area (21) of the control lever (19b) is defined by an outer side (27a; 29a) of a hollow cylindrical sleeve (27; 29) connected to the control lever (19b), the hollow cylindrical sleeve (27; 29) extending along the axis of rotation (19g) of the control lever (19b) from a lateral face of the control lever (19b).

22. The parking lock device of claim 17, wherein the stop surface (20) is substantially perpendicular or substantially parallel to the axial direction (X).

23. The parking lock device of claim 17, wherein the control lever (19b) is a stamped and bent sheet-metal part, the contact area (21) of the control lever (19b) being at least partially defined by a bent portion of the control lever (19b).

24. The parking lock device of claim 17, wherein the stop surface (22) is defined by an end face of an L-shaped component (30), the L-shaped component (30) being at least one of integrally bonded, frictionally fixed, or interlockingly fixed to the housing (23).

25. The parking lock device of claim 17, wherein the stop surface (22) is defined by a lateral face of a flat bar (33), the flat bar (33) being at least one of integrally bonded, frictionally fixed, or interlockingly fixed to the housing (23).

26. The parking lock device of claim 17, wherein the stop surface (22) is defined by a lateral face of a flat mounting plate (34), the flat mounting plate (34) being at least one of integrally bonded, frictionally fixed, or interlockingly fixed to the housing (23) at multiple fastening regions (38, 39, 40) spaced apart from each other, the multiple fastening regions being substantially level with the stop surface (22).

27. The parking lock device of claim 26, wherein the flat mounting plate (34) has multiple support regions (41, 42, 43) spaced apart from each other, each of the multiple support regions extending away from a respective one of the multiple fastening regions (38, 39, 40) and resting against an outer side (44) of the housing (23).

28. The parking lock device of claim 27, wherein each of the multiple support regions (41, 42, 43) are bent, each of the multiple support regions (41, 42, 43) being preloaded against the housing (23).

29. The parking lock device of claim 26, wherein the mounting plate (34) has a folded edge (45), the folded edge (45) increasing a stiffness of the mounting plate (34).

30. An automatic transmission (200), comprising the parking lock device (100) of claim 16.
